(19) United States
(12) Patent Application Publication
(10) Pub. No.: US 2011/0266759 A1
(43) Pub. Date: Nov. 3, 2011

(54) OSCILLATING TOOL

(75) Inventor: David A. Goldman, Phoenix, MD (US)

(73) Assignee: Black & Decker Inc., Newark, DE (US)

(21) Appl. No.: 13/044,811

(22) Filed: Mar. 10, 2011

Related U.S. Application Data
(63) Continuation-in-part of application No. 12/942,098, filed on Nov. 9, 2010.
(60) Provisional application No. 61/329,480, filed on Apr. 29, 2010.

(51) Int. Cl. B23B 31/08; B23B 31/103

(52) U.S. Cl. 279/106

(57) ABSTRACT

A clamp arrangement for securing first and second accessories to an oscillating power tool can include a tool body including a motor that drives the first accessory. A clamp assembly can include a first clamp member that moves relative to the accessory between a closed position wherein the clamp assembly retains the first accessory and an open position wherein the first clamp member of the clamp assembly is offset from the first accessory permitting removal of the first accessory while the first clamp member remains coupled to the clamp assembly. The clamp assembly further includes a second clamp member that cooperates with the first clamp member to clamp the first accessory between the first and second clamp members. An auxiliary attachment surface is configured on the second clamp member and selectively connects with the second accessory while the first accessory is concurrently retained by the clamp assembly.

### CROSS-REFERENCE TO RELATED APPLICATIONS

This application is a continuation-in-part of U.S. patent application Ser. No. 12/942,098 filed on Nov. 9, 2010, which claims the benefit and priority of U.S. Provisional Application No. 61/329,480, filed Apr. 29, 2010. The entire disclosure of the above application is incorporated herein by reference.

### FIELD

The present disclosure relates to power hand tools and more specifically to a clamp arrangement for releasably securing an accessory to an oscillating power hand tool.

### BACKGROUND

This section provides background information related to the present disclosure which is not necessarily prior art.

Power hand tools are provided in many examples for performing a wide range of tasks. For example, some power hand tools can include an output member that is driven by a motor and that couples with an accessory to perform a working operation onto a work piece. For example, some hand tools can provide various configurations for attaching cutting accessories, grinding accessories, sanding accessories and the like. Some power hand tools are configured as oscillating tools that are operable to transmit an oscillating motion onto the accessory.

During the course of performing a working operation, a user may want to exchange one accessory for another accessory. For example, a user may want to exchange one grinding accessory with another grinding accessory or one sanding platen with another sanding platen. Alternatively, a user may wish to replace a cutting accessory with another cutting accessory. It is also contemplated that a user may want to replace a given accessory dedicated to one task (such as sanding) with another accessory dedicated toward another task (such as cutting for example). In any event, many power hand tools require the use of a secondary tool to swap out accessories. For example, many power hand tools require the use of a hand screw driver that can be used to retract a fastener that may lock the accessory to the output member of the power hand tool. In other examples, a wrench or other hand tool may be required to remove or unlock a given accessory from the power hand tool and subsequently lock another accessory back to the power hand tool.

### SUMMARY

This section provides a general summary of the disclosure, and is not a comprehensive disclosure of its full scope or all of its features.

A clamp arrangement for securing first and second accessories to an oscillating power tool can include a tool body including a motor that drives the first accessory. A clamp assembly can include a first clamp member that moves relative to the accessory between a closed position wherein the clamp assembly retains the first accessory and an open position wherein the first clamp member of the clamp assembly is offset from the first accessory permitting removal of the first accessory from the clamp assembly while the first clamp member remains coupled to the clamp assembly. The clamp assembly further includes a second clamp member having a first portion that opposes the first clamp member and cooperates with the first clamp member to clamp the first accessory between the first and second clamp members. An auxiliary attachment surface is configured on the second clamp member and selectively connects with the second accessory while the first accessory is concurrently retained by the clamp assembly.

According to other features, the first clamp member comprises a first clamp body having one of a first plurality of protrusions extending from a first clamping surface and a first plurality of recesses formed into the first clamping surface. The second clamp member comprises a second clamp body having a second clamping surface that opposes the first clamping surface and includes the other of the first plurality of protrusions and first plurality of recesses. The first plurality of protrusions are configured to cooperatively locate into the corresponding first plurality of recesses in the closed position.

A lever can have a user engagement portion and a pivot portion including a pivot axle. The lever can be pivotally coupled to the tool body about the pivot axle between a first position, wherein the clamp assembly is in the closed position and a second position wherein movement of the user engagement portion of the lever causes the clamp assembly to be moved to the open position. The user engagement portion of the lever can be positioned intermediate the tool housing and the accessory.

According to additional features, the second clamp member defines a threaded bore configured to receive a fastener that couples the second accessory to the auxiliary attachment surface. The second accessory can comprise a depth control member having a work piece engagement surface that is configured to be spaced a predetermined distance from a cutting edge of the first accessory. The work piece engagement surface can be configured to engage the work piece and inhibit the cutting edge from cutting into a work piece a distance greater than the predetermined distance.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a clamp arrangement constructed in accordance to one example of the present teachings and shown operatively associated with an exemplary power hand tool for releasably securing a first or a second accessory;

FIG. 2 is a perspective view of a clamp assembly of the clamp arrangement shown in FIG. 1 and shown with the clamp assembly in the closed position retaining the first accessory;

FIG. 3 is an exploded perspective view of the clamp assembly of FIG. 2;

FIG. 4 is a sectional view of the clamp assembly of FIG. 2 and shown with the clamp assembly in the closed position and a lever of the clamp assembly in a first position;

FIG. 5 is a cross-sectional view of the clamp assembly of FIG. 4 and shown with the clamp assembly in the open position resulting from the lever being rotated about a pivot axle into a second position wherein the first accessory is subsequently lifted out of engagement with the first clamp member;

FIG. 6 is a cross-sectional view of the clamp assembly of FIG. 5 shown with the clamp assembly in the open position and the lever in the second position and illustrating the first accessory being removed from the clamp assembly;

FIGS. 7-9 are perspective views of the clamp assembly that generally correspond to the sequence illustrated in FIGS. 4-6 for removing the first accessory from the clamp assembly;

FIGS. 10-12 are perspective views of the clamp assembly that illustrate an exemplary sequence of orienting the first accessory in a different rotational position relative to the clamp assembly;

FIGS. 13-15 are cross-sectional views of the clamp assembly taken through a spindle of the power hand tool and shown with the first accessory rotated at different positions around an axis of the spindle;

FIG. 16 is a perspective view of the clamp arrangement of the present teachings and shown with the clamp assembly secured to the second accessory;

FIG. 17 is an exploded perspective view of the clamp assembly and second accessory illustrated in FIG. 16;

FIG. 18 is a sectional view of the clamp assembly of FIG. 16 and shown with the clamp assembly in the open position resulting from movement of the lever around the pivot axle to the second position for receipt of a mounting collar of the second accessory;

FIG. 19 is a cross-sectional view of the clamp assembly of FIG. 18 and shown with the mounting collar of the second accessory positioned generally between first and second clamp members of the clamp assembly while the lever is maintained in the second position;

FIG. 20 is a cross-sectional view of the clamp assembly of FIG. 19 and illustrating the clamp assembly in the closed position as a result of the lever being released and returned to the first position causing the first and second clamp members to clamp the mounting collar;

FIG. 21 is a perspective view of an exemplary third accessory;

FIG. 22 is a partial cross-section of the clamp assembly and shown with the third accessory secured to an auxiliary mounting surface of the second clamp member;

FIGS. 23-25 illustrate an exemplary assembly sequence of a fourth accessory having a throat that defines a relatively narrower opening as compared to the first accessory wherein the throat is slidably directed through channels provided on the spindle;

FIG. 26 is an exploded partial plan view of the fourth accessory and shown adjacent to the second clamp member and illustrated with the spindle in cross-section taken through the channels;

FIG. 27 is a partial plan view of a fifth accessory having circular mounting passages according to additional features;

FIG. 28 is a partial plan view of the fifth accessory shown in FIG. 27 and illustrated interfacing with the second clamp member;

FIG. 29 is a side view of a clamp arrangement constructed in accordance to another example of the present teachings and shown operatively associated with an exemplary hand tool;

FIG. 30 is a sectional view of the clamp assembly of FIG. 29 and shown with the clamp assembly in a closed position and a lever of the clamp assembly in a first position;

FIG. 31 is a perspective view of the second clamp member of the clamp assembly of FIG. 30;

FIG. 32 is a plan view of an accessory constructed in accordance to one example of the present teachings;

FIG. 33 is a side view of the accessory of FIG. 32 shown placed on the second clamp member and shown with the first clamp member removed for illustrative purposes;

FIG. 34 is a side view of the clamp assembly shown during removal of the accessory where the lever is moved from the first position (phantom) to a second position (solid line) and the first clamp member is raised away from engagement with the accessory;

FIG. 35 is a side perspective view of a clamp arrangement constructed in accordance to another example of the present teachings and shown operatively associated with an exemplary hand tool, the clamp arrangement having a clamp assembly that concurrently retains a first and a second accessory;

FIG. 36 is a bottom perspective view of the clamp assembly of FIG. 35;

FIG. 37 is a bottom perspective view of the clamp assembly of FIG. 35 and shown with the second accessory in exploded view prior to coupling with the clamp assembly;

FIG. 38 is a cross-sectional view of the clamp assembly taken along lines 38-38 of FIG. 36;

FIG. 39 is a partial cross-sectional view of the clamp assembly of FIG. 35 and shown with an alternate second accessory that incorporates a bearing according to various features of the present disclosure;

FIG. 40 is a side perspective view of the clamp arrangement of FIG. 35 and shown retaining the first accessory and a second accessory that is constructed in accordance to additional features of the present teachings;

FIG. 41 is a cross-sectional view of the clamp assembly taken along lines 41-41 of FIG. 40 and shown with various second accessories having alternate heights according to various features of the present teachings;

FIG. 42 is a side perspective view of the clamp assembly of FIG. 35 and shown with the clamp assembly retaining the first accessory and a second accessory constructed in accordance to other features of the present teachings;

FIG. 43 is a cross-sectional view of the clamp assembly taken along lines 43-43 of FIG. 42 and shown with various second accessories having various heights and depths according to the present teachings;

FIG. 44 is a perspective view of the clamp assembly of FIG. 35 and shown with a collection of second accessories having various dimensions according to the present teachings;

FIG. 45 is a cross-sectional view of the clamp arrangement and shown with first and second accessories concurrently retained by the clamp assembly and constructed in accordance to various features; and

FIG. 46 is a cross-sectional view of the clamp assembly of FIG. 35 and shown with a first and a second accessory concurrently retained according to various additional features.

Corresponding reference numerals indicate corresponding parts throughout the several views of the drawings.

### DETAILED DESCRIPTION

Example embodiments will now be described more fully with reference to the accompanying drawings.

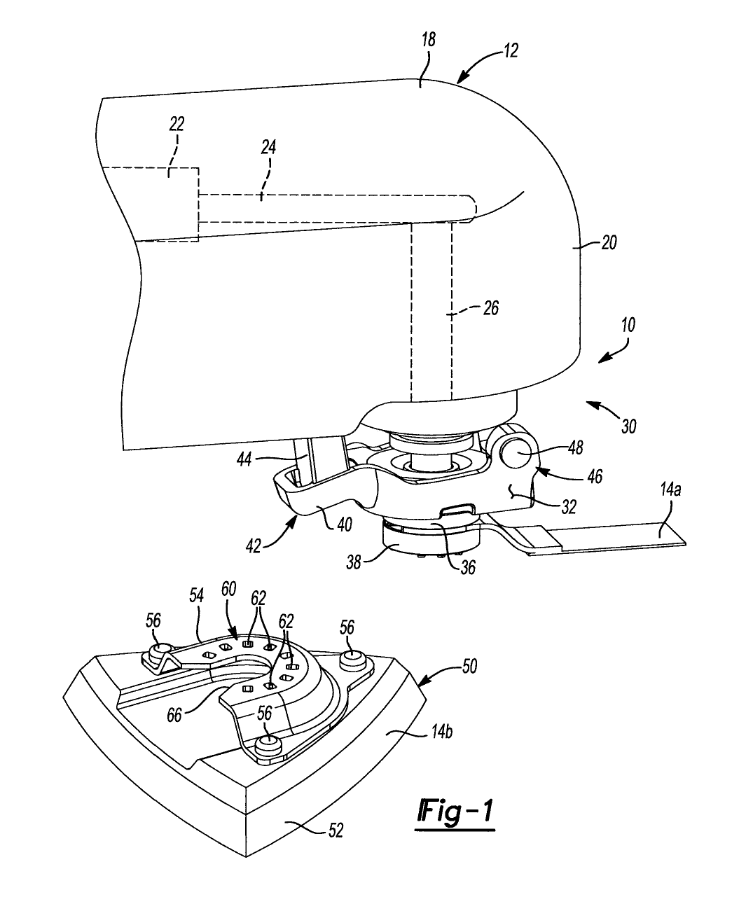

With initial reference to FIG. 1, a clamp arrangement constructed in accordance to one example of the present disclosure is shown and generally identified at reference numeral 10. The clamp arrangement 10 is shown operatively associated with a power tool 12 for selectively and alternatively retaining various accessories, such as a first accessory 14a or a second accessory 14b. The exemplary power tool can generally include a tool body 18 including a housing 20 that generally contains a motor 22 that drives an output member 24. The output member 24 can be coupled to a spindle 26. The exemplary power tool 12 is configured for providing an oscillating motion onto the spindle 26. It will be appreciated that while the clamp arrangement 10 is disclosed herein as part of an oscillating power hand tool, the clamp arrangement 10 may be also configured for use with other power tools that releasably secure an accessory.

The clamp arrangement 10 can further include a clamp assembly 30 that operatively cooperates with an actuator such as a lever 32. The clamp assembly 30 can generally include a first clamp member 36 and a second clamp member 38. The lever 32 can include a lever arm 40 that includes a user engagement portion 42 and a block 44. The lever 32 can further include a pivot portion 46 having a pivot axle 48.

With continued reference to FIG. 1, the second accessory 14b will be briefly described. The second accessory 14b can generally include a sanding platen 50 having a platen body 52 and a mounting collar 54. In the example shown, the mounting collar 54 can be coupled to the body 52 by way of a series of fasteners 56. The body 52 can be configured to support an abrasive sheet, such as sand paper and the like as is known in the art. The mounting collar 54 can generally include an upper plate portion 60 having a plurality of mounting features 62. In the example shown, the mounting features 62 are generally in the form of passages formed through the mounting collar 54. The mounting collar 54 can generally include an open-ended aperture or throat 66 configured to accept the spindle 26 in an assembled position as will be described herein.

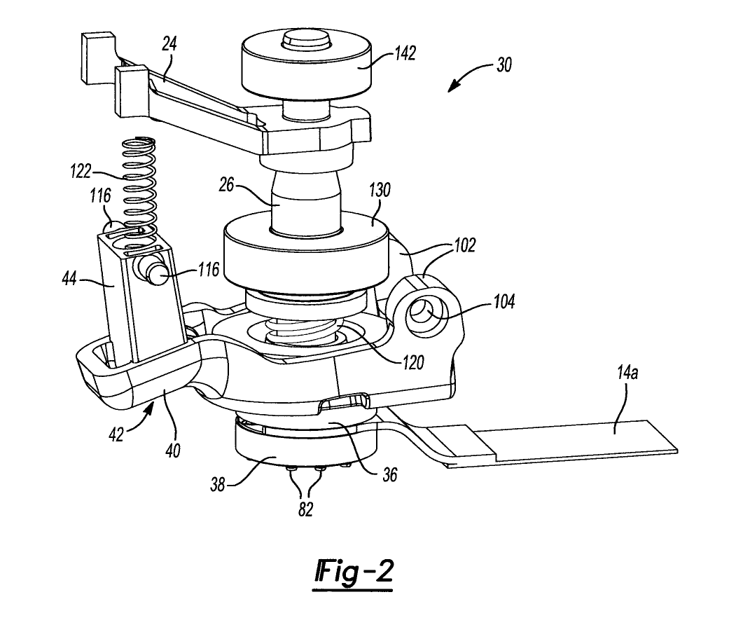

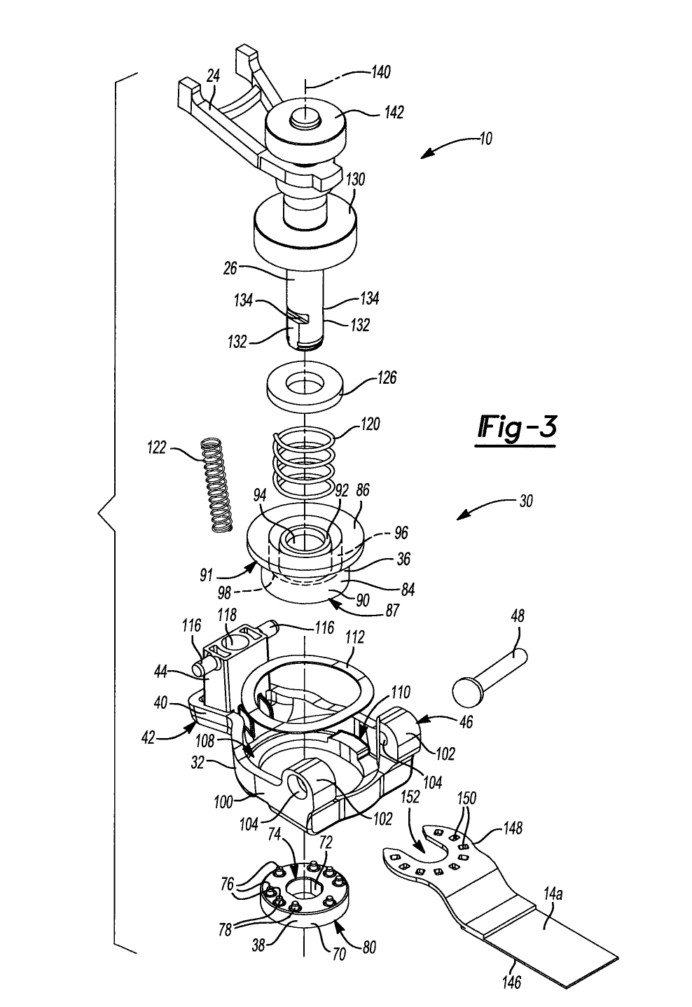

With additional reference now to FIGS. 2 and 3, the clamp assembly 30 will be described in greater detail. The second clamp member 38 can include a second clamp body 70 generally in the form of a ring having a central opening 72. The second clamp body 70 can generally comprise a second clamping surface 74 having a plurality of mounting features 76 formed thereon. In the example shown, the plurality of mounting features 76 are in the form of male protrusions 78. In the particular example shown, eight protrusions each having a tapered shape or form are provided. However, other configurations are contemplated. The second clamp body 70 can additionally include an auxiliary attachment surface 80 having a plurality of auxiliary mounting features 82 (FIG. 2). Again, the plurality of auxiliary mounting features 82 are shown in the form of male protrusions and may include a similar eight protrusion configuration as provided on the second clamping surface 74. The auxiliary mounting features 82 can each have a diameter of 2.4 mm. Other configurations are contemplated.

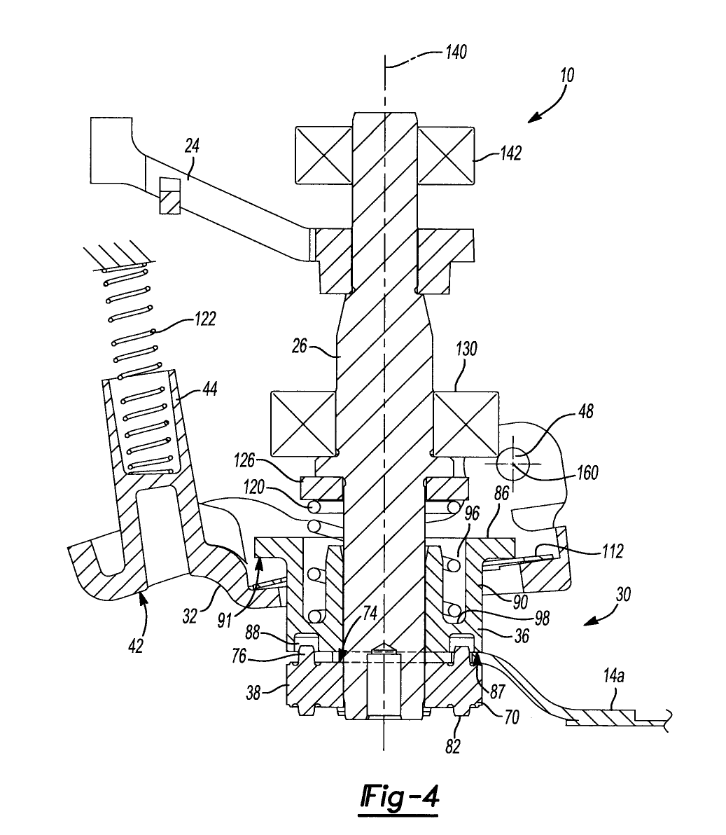

With reference now to FIGS. 3 and 4, the first clamp member 36 can generally include a first clamp member body 84 having an annular flange 86. The first clamp member body 84 can include a first clamping surface 87 having a plurality of mounting features 88 (FIG. 4). In the example shown, the plurality of mounting features 88 are in the form of recesses that cooperatively receive the corresponding plurality of mounting features 76 of the second clamp member 38. The mounting features 88 can have any configuration, such as blind bores, or circular grooves being suitable to accept the male protrusions of the mounting features 76. The annular flange 86 can generally extend radially on an end of an outer hub 90 of the first clamp member body 84. The annular flange 86 can have a lever opposing surface 91. The first clamp member body 84 can further include an inner hub 92 that defines a first clamp member opening 94. The first clamp member opening 94 can be configured to receive the spindle 26. An annular channel 96 can be formed between the outer hub 90 and the inner hub 92. The annular channel 96 can have a terminal surface 98.

The lever 32 can generally include a lever body 100 having the user engagement portion 42 formed generally on a first end and the pivot portion 46 formed on an opposite end. According to one example, the pivot portion 46 can generally include a pair of lobes 102 that each define an axle passage 104. The lever body 100 can further include a pocket 108 having a flange opposing surface 110 for generally receiving two steel balls and the annular flange 86 of the first clamp member 36. The block 44 can generally include a pair of transverse posts 116 and a blind bore 118. The axle passages 104 provided in the lobes 102 can be configured to receive the pivot axle 48.

The clamp arrangement 10 can additionally include a first biasing member 120 and a second biasing member 122. The first biasing member 120 can be at least partially received by the annular channel 96 provided on the first clamp member body 84. The second biasing member 122 can be at least partially received into the blind bore 118 of the block 44. The first biasing member 120 can be generally supported on an upper end by a washer 126 that is correspondingly supported by a bearing 130 journalled around the spindle 26. The spindle 26 can additionally include a pair of flats 132 and channels 134 formed on a distal end. The flats 132 can generally correspond to the profile of the opening 72 formed in the second clamp member 38. The flats 132 can cooperate with the profile of the opening 72 to key the second clamp member 38 to the spindle 26 and inhibit rotation of the second clamp member 38 around a spindle axis 140. In the example provided, the output member 24 can be generally in the form of a drive fork that can impart rotational motion onto the spindle 26 around the spindle axis 140. Other configurations are contemplated. A support bearing 142 can be arranged on one end of the spindle 26 for cooperatively mounting within the housing 20.

Returning to FIG. 3, the first accessory 14a can be generally in the form of a cutting member having a working portion 146 and an attachment portion 148. The attachment portion 148 can include a plurality of mounting features 150 in the form of passages formed through the first accessory 14a. The attachment portion 148 can further include an open-ended aperture or throat 152 for selectively receiving a portion of the spindle 26 in an assembled position as will be described herein.

With specific reference now to FIGS. 4-6, an exemplary sequence of removing the first accessory 14a from the clamp assembly 30 will be described according to one example of the present teachings. With initial reference to FIG. 4, the clamp assembly 30 is shown in a closed position wherein the biasing member 120 is supported on a first end by the washer 126 and provides a downward biasing force onto the first clamp member 36 at the annular channel 96. It is important to recognize that in the particular example shown, the second clamp member 38 is fixed to the spindle 26. As shown, the male protrusions of the mounting features 76 selectively locate into the recesses of the mounting features 88 formed on the first clamp member 36. The first accessory 14a therefore is clamped between the second clamping surface 74 and the first clamping surface 87 while the male protrusions of the mounting features 76 locate through passages of the mounting features 150 formed on the first accessory 14a. Those skilled in the art will recognize that while some of the mounting features are described and shown as male protrusions and some of the mounting features are described and shown as recesses, the locations may be swapped. Moreover, other interlocking geometries may be used. As viewed in FIG. 4, the lever 32 is shown and generally described herein as the first position.

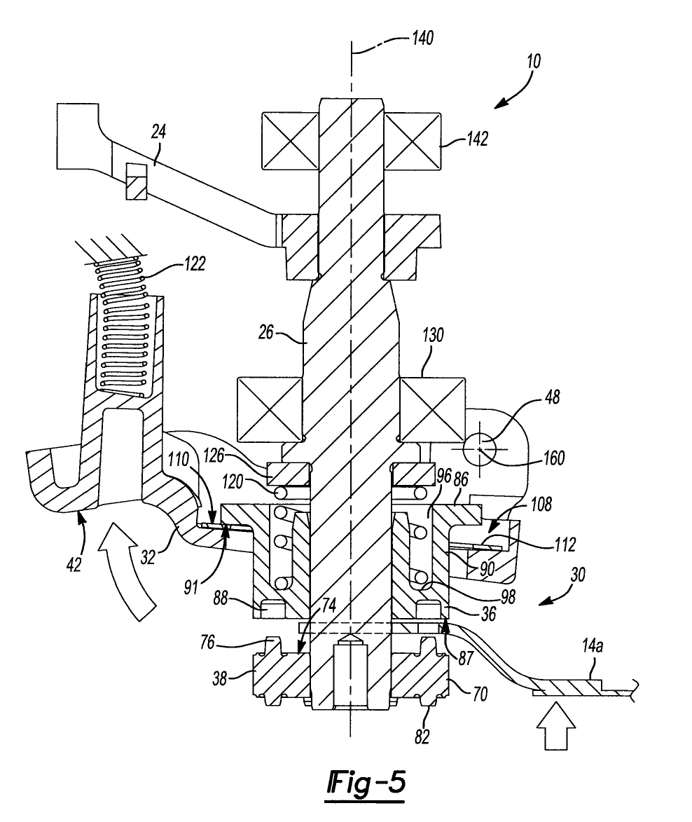

With specific reference now to FIG. 5, the lever 32 is shown rotated around a pivot axle axis 160 of the pivot axle 48 to a second position. In the second position, the clamp assembly 30 is generally in the open position where the first clamp member 36 is displaced or offset relative to the second clamp member 38. In order to move the lever 32 from the first position (FIG. 4) to the second position (FIG. 5), a user can urge the user engagement portion 42 (such as by pulling the user engagement portion 42 with an index finger) in a direction generally upwardly as viewed in FIG. 5 and toward the housing 20. In order to rotate the lever 32 around the pivot axle 48, a user must overcome the biasing forces of the respective first and second biasing members 120 and 122. During rotation of the lever 32 around the pivot axle 48, the flange opposing surface 110 in the pocket 108 of the lever body 100 (FIG. 3) generally transmits an upward force (in a direction against the biasing force of the first biasing member 120) onto the lever opposing surface 91. In this regard, the lever 32 can generally lift the first clamp member 36 at the annular flange 86 to move the first clamping surface 87 away from the second clamping surface 74. It will be appreciated that other mechanical configurations other than a lever that pivots about a pivot axle may be used. For example, a camming configuration or slidable actuation member may be additionally or alternatively employed.

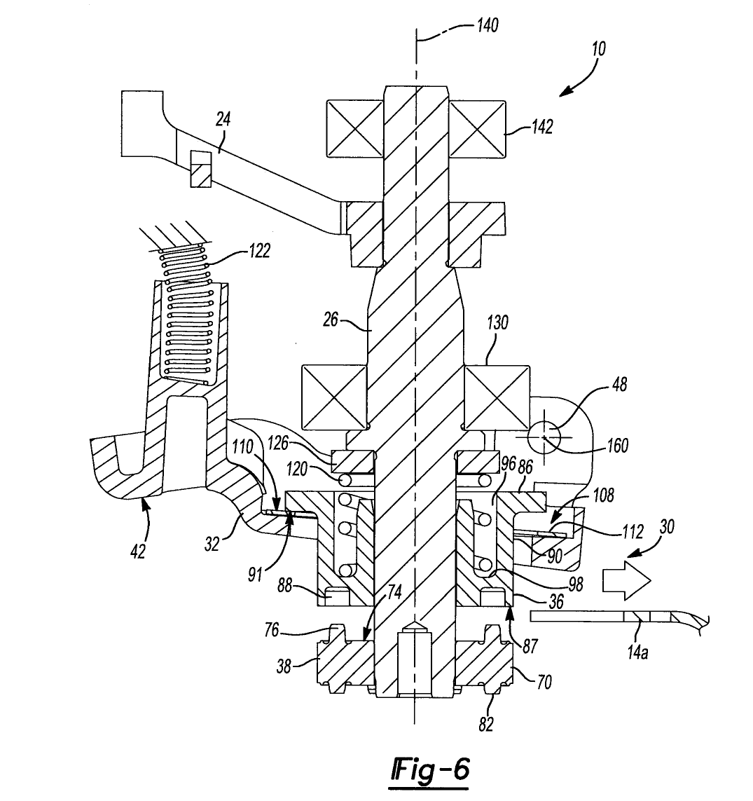

With the clamp assembly 30 in the open position, the first and second clamp members 36 and 38, respectively, provide enough clearance, such that a user can remove the first accessory 14a away from the clamp assembly 30. In one example, it may be necessary to initially lift the first accessory 14a away from the male protrusions of the mounting features 76 before pulling the first accessory 14a away from the clamp assembly 30 (FIG. 6).

The clamp arrangement 10 of the present disclosure can provide a significant mechanical advantage that can provide a particularly robust clamping action onto an accessory in a tight package requiring relatively small space. In this regard, by mounting the pivot axle 48 on an opposite end of the user engagement portion 42 a user be offered a significant moment arm that can act against the respective biasing forces of the first and second biasing members 120 and 122 while still offering a significant clamping force. According to other advantages, the location of the user engagement portion 42 provides an ergonomically pleasing configuration adjacent to the housing 20 where a user's palm would be generally positioned. In this regard, an index finger can easily negotiate onto the user engagement portion 42 without having to significantly reposition a user's palm. Moreover, the user engagement portion 42 can be generally located between the housing 20 and the first accessory 14a, such that a user can easily pull up on the user engagement portion 42 in a direction toward the housing with one hand while removing/installing any given accessory with the other hand.

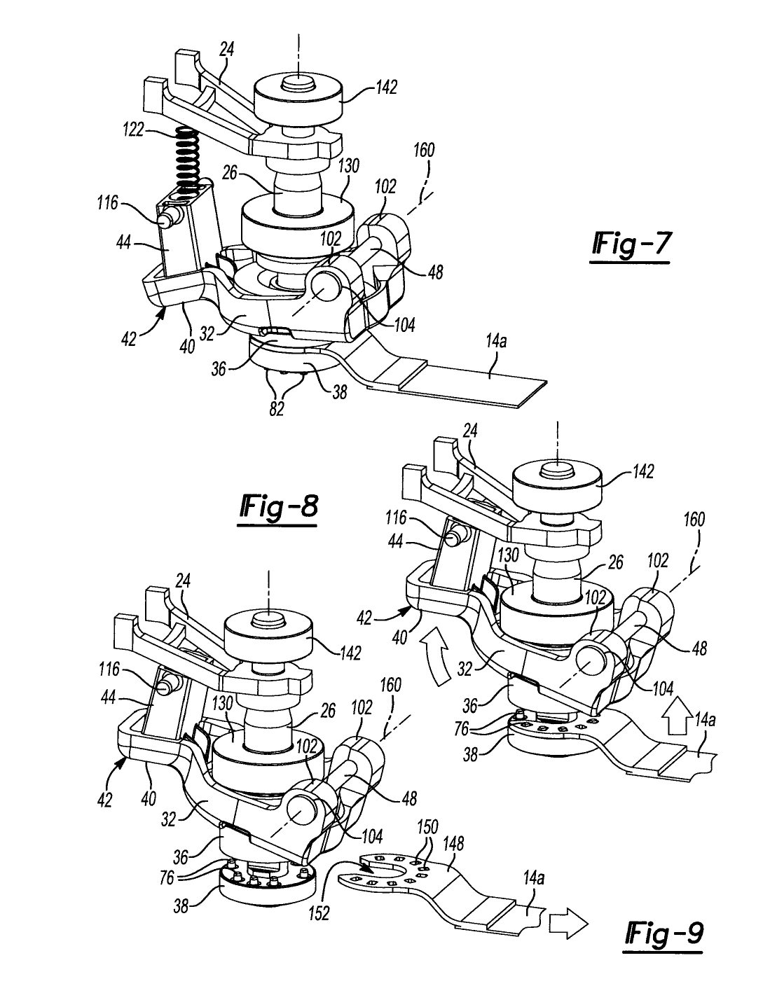

With specific reference now to FIGS. 7-9, perspective views of the clamp assembly 30 are shown wherein FIG. 7 generally corresponds to the sectional view of FIG. 4 of the clamp assembly 30 in the closed position and the lever 32 in the first position. FIG. 8 generally corresponds to the sectional view of FIG. 5 where the clamp assembly 30 is in the open position and the lever 32 is in the second position. FIG. 9 generally corresponds to the sectional view of FIG. 6 where the clamp assembly 30 is in the open position and the lever 32 is in the second position while the first accessory 14a is removed from the clamp assembly 30.

With reference now to FIGS. 10-12, the clamp assembly 30 can be used to selectively clamp a given accessory, such as the first accessory 14a through a variety of rotational orientations around the spindle axis 140. As identified above, the second clamp member 38 includes eight mounting features 76 however other configurations may be incorporated. The first accessory 14a includes nine mounting features or passages 150. The first accessory 14a can be arranged in a plurality of different rotational orientations, such that the male protrusions 78 can be aligned for passing through the passages 150 by rotating the first accessory 14a into the orientation desired. As can be appreciated, it may be advantageous to orient the first accessory 14a differently for a particular task. Once the passages 150 are aligned for receipt of the male protrusions 78 on the second clamp member 38 the attachment portion 148 of first accessory is dropped onto the second clamping surface 74.

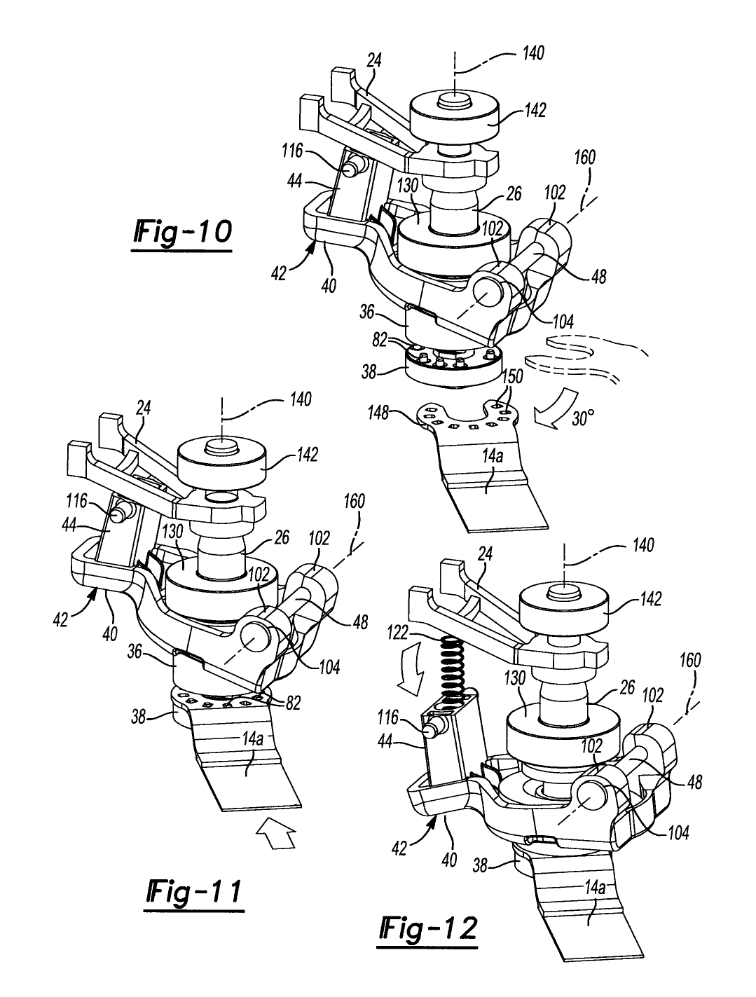

In the exemplary sequence shown in FIGS. 10-12, a user can initially pull up the lever 32 at the user engagement portion 42 causing the annular flange 86 of the first clamp member 36 to be lifted as previously described. With the first clamp member 36 displaced from the second clamp member 38, the first accessory 14a can be oriented into the desired radial position and aligned with the corresponding male protrusions 78. The user can then release the user engagement portion 42 allowing the first biasing member 120 (and the second biasing member 122) to urge the first clamp member 36 in a direction toward the second clamp member 38 until the respective first and second clamping surfaces 87 and 74, respectively, engage and clamp the attachment portion 148 of the first accessory 14a (FIG. 12).

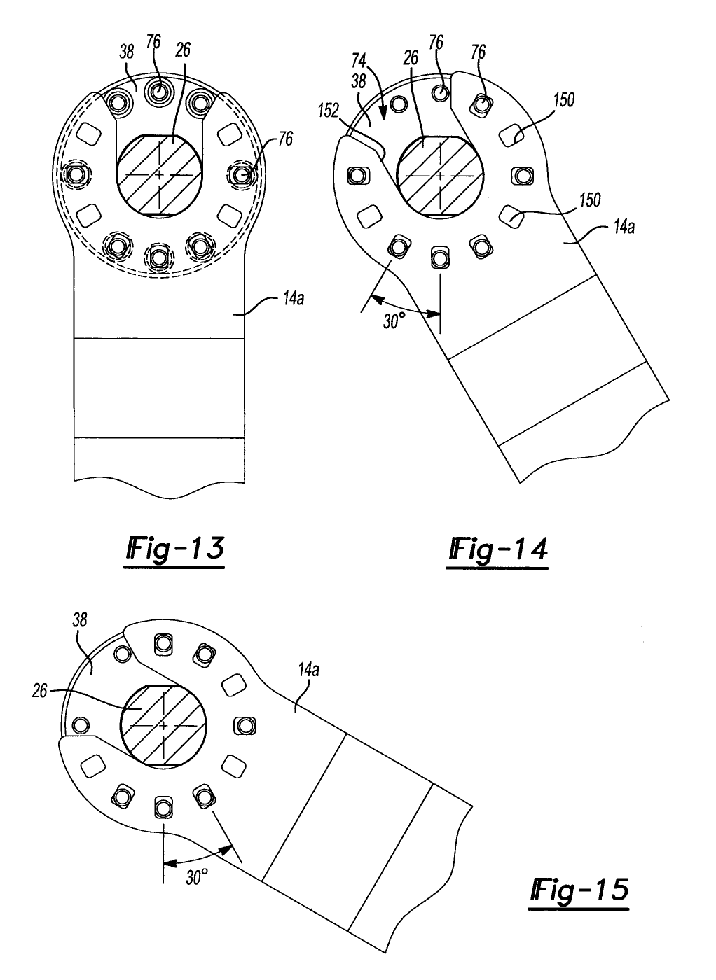

Turning now to FIGS. 13-15, various examples are shown with the first accessory 14a mounted around the second clamp member 38. In the examples shown, the male protrusions of the mounting features 76 can be arranged to allow the first accessory 14a to be indexed at about thirty degree increments around the second clamping surface 74. When describing the male protrusions of the mounting features 76 in the context of a clock, mounting features are absent at the two, four, eight and ten o'clock positions. Other examples are contemplated.

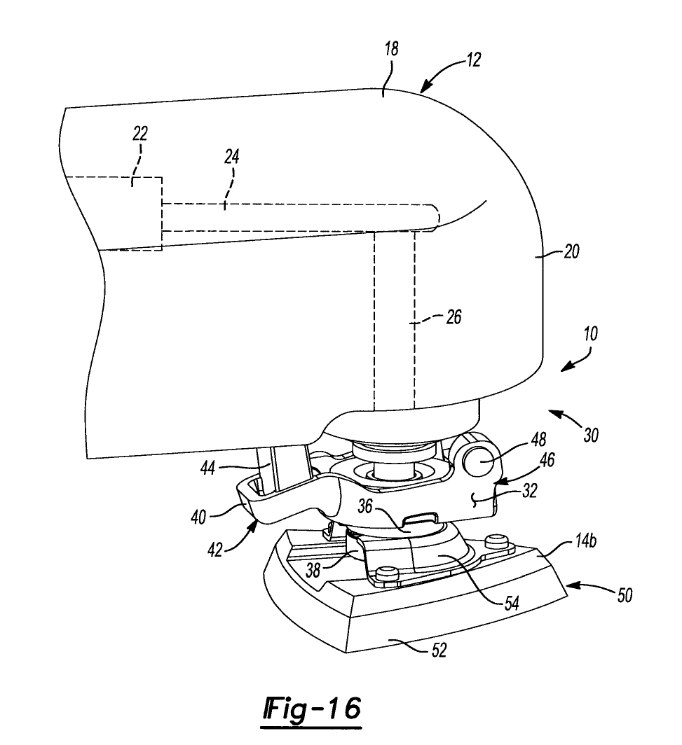

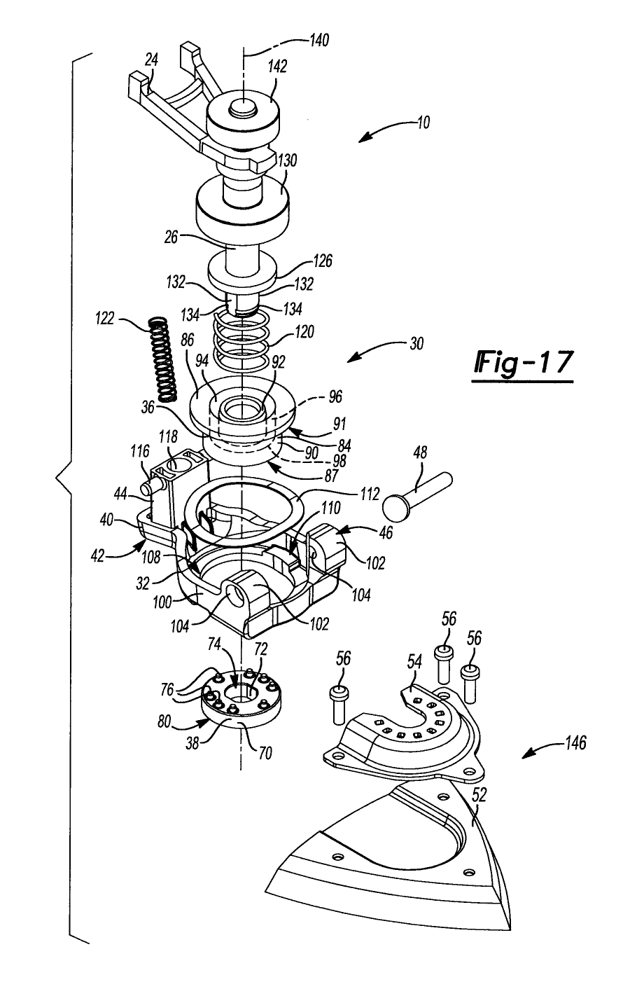

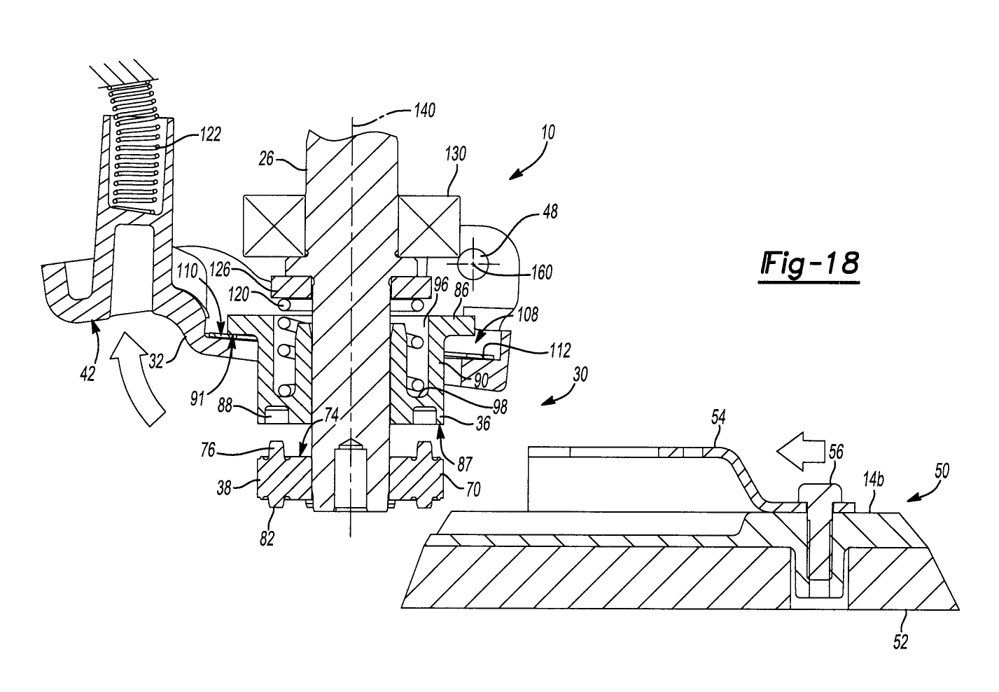

With reference now to FIGS. 16-20, the clamp assembly 30 will be described clamping the second accessory 14b according to one example of the present teachings. As described above, the clamp assembly 30 is normally biased into the closed position. As illustrated in FIG. 18, the lever 32 is shown rotated around the pivot axle axis 160 of the pivot axle 48 to the second position. In the second position, the clamp assembly 30 is generally in the open position where the first clamp member 36 is displaced relative to the second clamp member 38. With the clamp assembly 30 in the open position, the first and second clamp members 36 and 38, respectively provide enough clearance to accept the mounting collar 54 of the second accessory 14b.

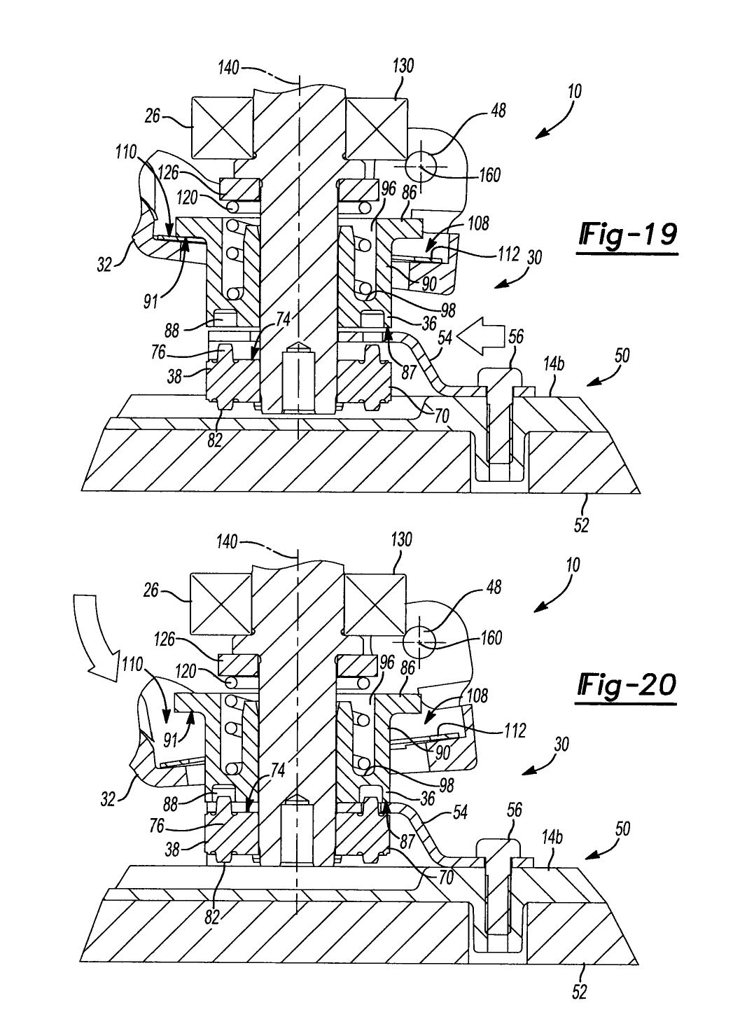

While a user maintains an upward force on the user engagement portion 42 of the lever 32, the second accessory 14b is directed toward the clamp assembly 30, such that the spindle 26 is generally located through the throat 66 (FIG. 19). Once the desired mounting features 62 of the mounting collar 54 are aligned with the desired mounting features 76 of the second clamp member 38, the user can release the user engagement portion 42 of the lever 32 allowing the respective first and second biasing members 120 and 122 to return the lever 32 to the first position (FIG. 20). In the first position, the clamp assembly 30 is in the closed position, such that the first clamping surface 87 of the first clamp member 36 as well as the second clamping surface 74 of the second clamp member 38 cooperatively clamp the mounting collar 54 of the second accessory 14b.

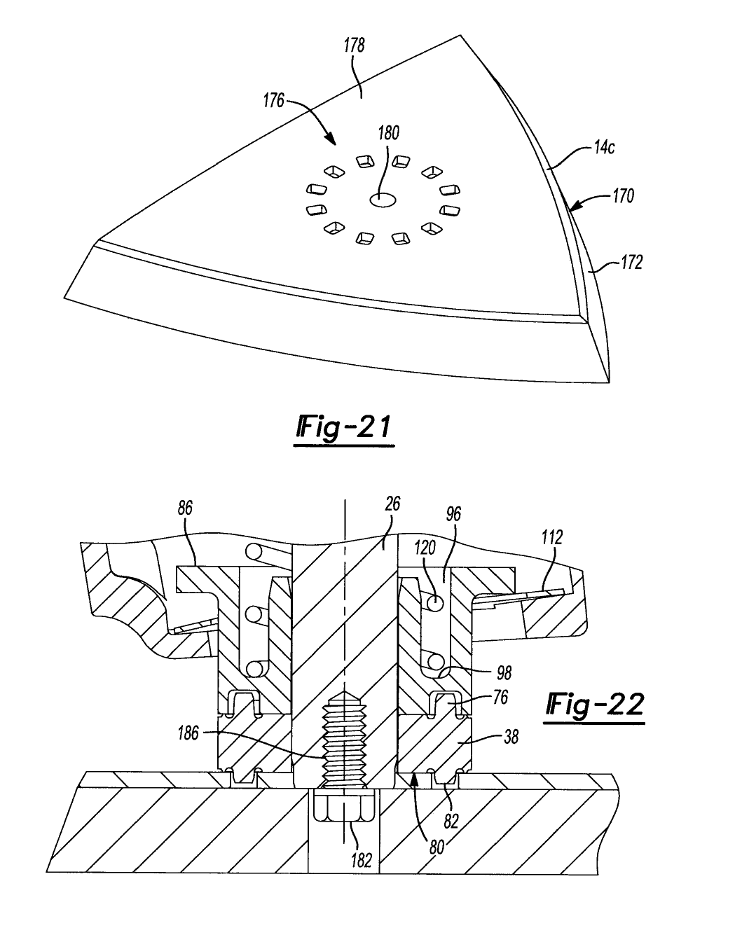

Turning now to FIGS. 21 and 22, a third accessory 14c and a method of attaching the third accessory 14c to the auxiliary attachment surface 80 of the second clamp member 38 will be described. The third accessory 14c can generally include a body 170 having a generally iron-shaped. A plurality of mounting features 176 can be formed around an upper surface 178 of the body 172 of the third accessory 14c. In the example shown, the plurality of mounting features 176 can be in the form of recesses having a profile that generally mates with the plurality of mounting features 82 extending from the auxiliary attachment surface 80. A mounting aperture 180 can be formed through the body 172 of the third accessory 14c for accepting a fastener 182 (FIG. 22). The fastener 182 can threadably mate with a threaded bore 186 defined at a distal end of the spindle 26. Those skilled in the art will readily appreciate that movement of the lever 32 will not affect the attachment of the third accessory 14c as the third accessory 14c only interfaces with the second clamp member 38 that is rigidly fixed to the spindle 26.

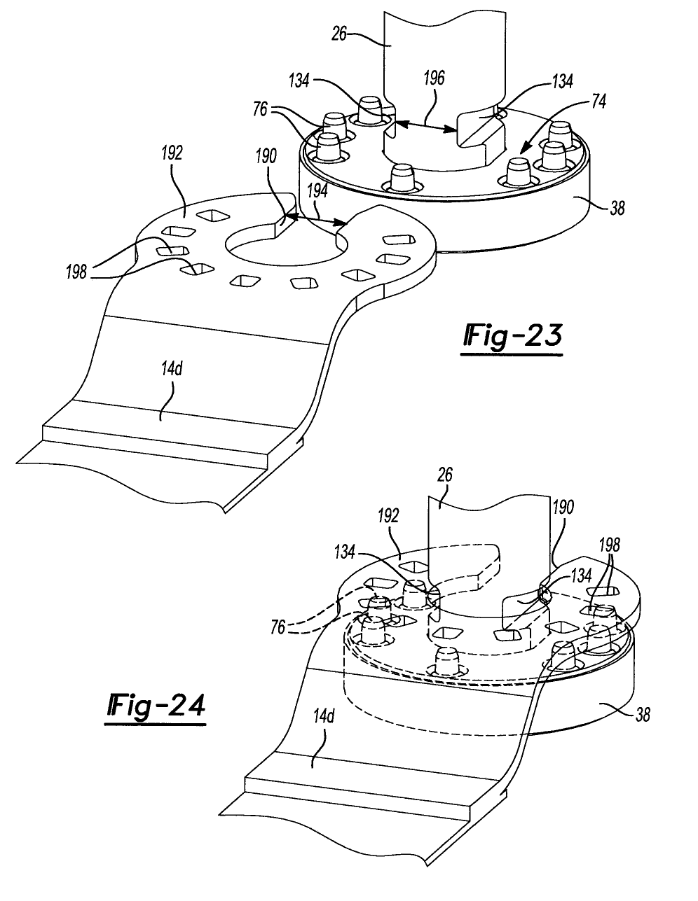

Turning now to FIGS. 23-26, a fourth accessory 14d will be described cooperating with the spindle 26 and the second clamp member 38. The channels 134 formed in the spindle 26 can provide clearance for accepting other accessories, such as accessories that may define a throat 152 having a smaller entrance. In this regard, the reduced geometry throat of an accessory may be initially negotiated through the channel 134 prior to rotating the accessory into the desired orientation relative to the spindle 26 and subsequently clamping the accessory to the clamp assembly 30.

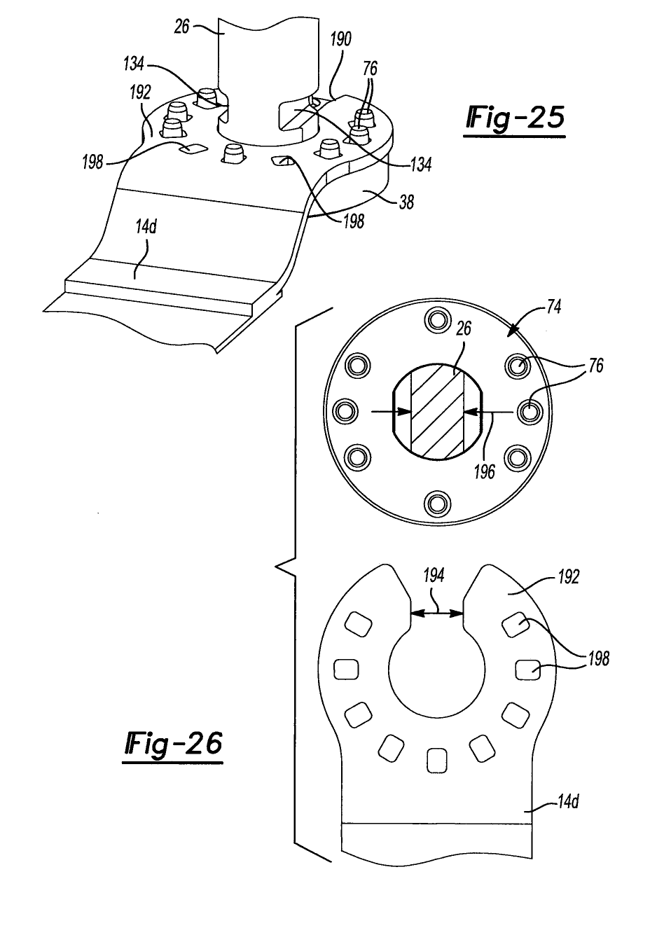

The fourth accessory 14d can have an open-ended aperture or throat 190 formed on an attachment portion 192. The throat 190 can generally span a distance 194. As compared to the throat 152 on the first accessory 14a, the throat 190 provides a reduced distance 194. The channels 134 provided on the spindle 26 are offset a distance 196 that is generally less than the distance 194, such that the throat 190 can be advanced through the channels 134 until clearing the channels 134 at an opposite end of the spindle 26 (see FIG. 24). Once the throat 190 has cleared the channels 134, a user can rotate the fourth accessory 14d to a desired orientation around the second clamping surface 74 of the second clamp member 38. Once the desired orientation has been attained, the attachment portion 192 of the fourth accessory 14d can be dropped onto the second clamping surface 74 while the male protrusions of the mounting features 76 locate through respective passages 198 formed through the attachment portion 192 on the fourth accessory 14d (FIG. 25). FIG. 26 illustrates a plan view that represents the relative distances 194 of the throat 190 and 196 of the channels 134.

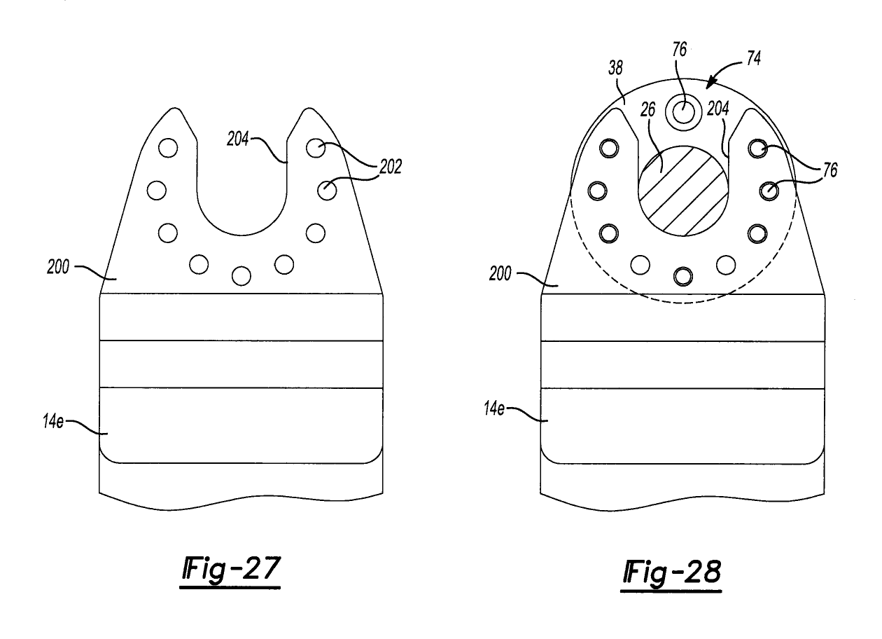

With reference now to FIGS. 27 and 28, a fifth accessory 14e is shown that has an attachment portion 200 having a plurality of mounting formations 202 formed therethrough. The mounting formations 202 can be generally in the form of circular apertures. The circular apertures can have a tapered shape. Other dimensions are contemplated that may still have a diameter (or opening in general) that is large enough to accept the diameter of the respective mounting features 76 on the second clamp member 38.

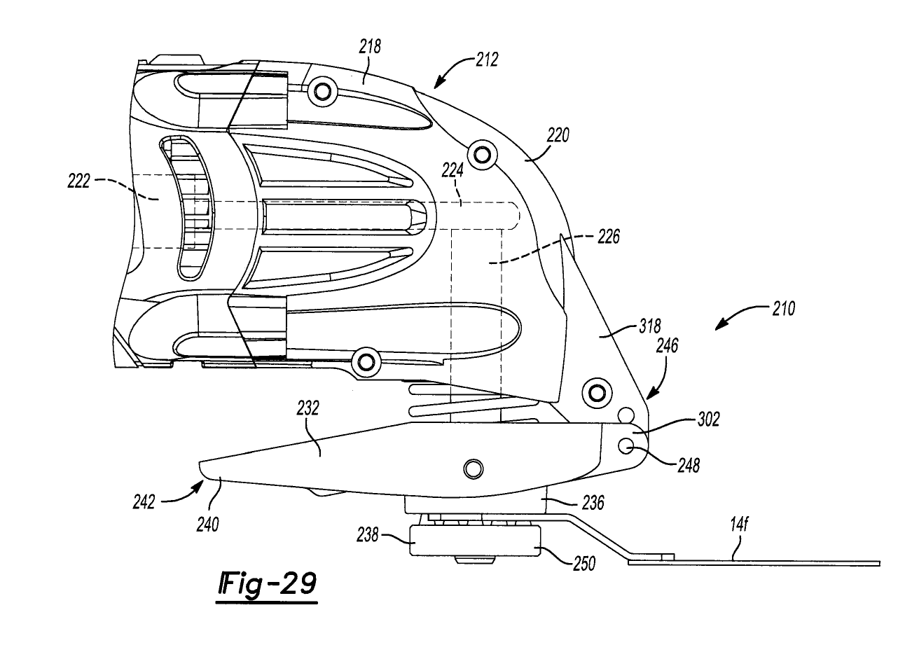

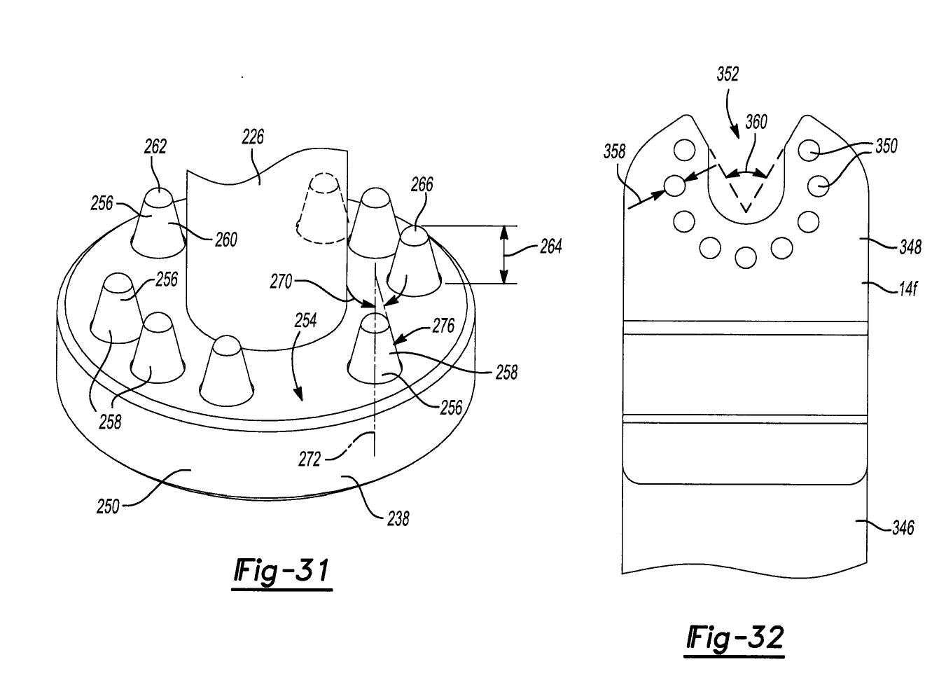

With reference now to FIGS. 29-34, a clamp arrangement constructed in accordance to another example of the present disclosure is shown and generally identified at reference numeral 210. The clamp arrangement 210 is shown operatively associated with a power tool 212 for selectively and alternatively retaining various accessories such as a sixth accessory 14f. The exemplary power tool 212 can generally include a tool body 218 including a housing 220 that generally contains a motor 222 that drives an output member 224. The output member 224 can be coupled to a spindle 226. The exemplary power tool 212 is configured for providing an oscillating motion onto the spindle 226. As with the clamp arrangement 10 described above, the clamp arrangement 210, while described herein as part of an oscillating hand tool, can also be used with other power tools that releasably secure an accessory.

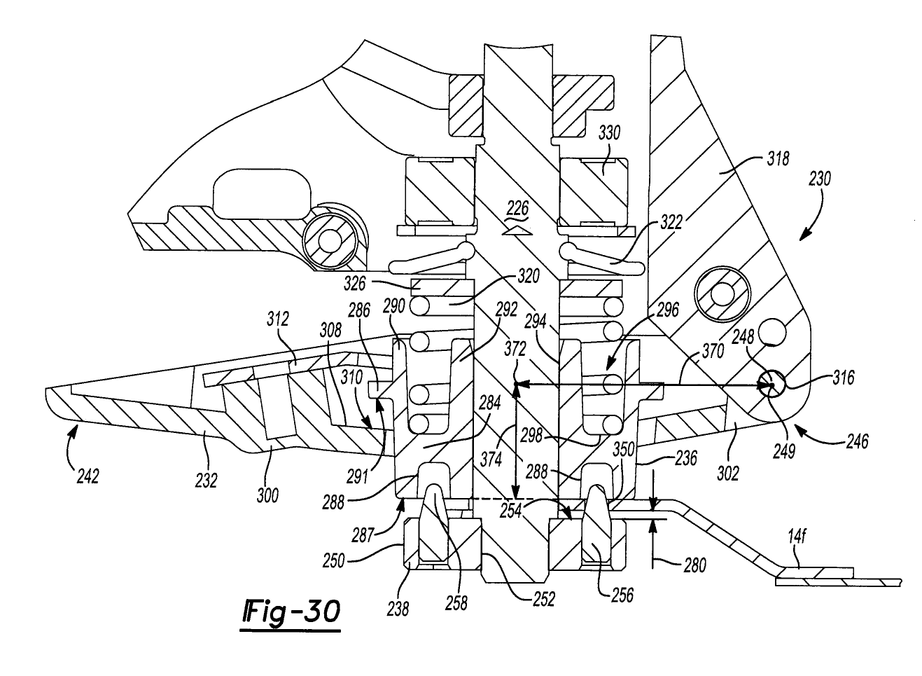

The clamp arrangement 210 can further include a clamp assembly 230 (FIG. 30) that operatively cooperates with a lever 232. The clamp assembly 230 can generally include a first clamp member 236 and a second clamp member 238. The lever 232 can include a lever arm 240 that includes a user engagement portion 242. The lever 232 can further include a pivot portion 246 having a pivot axle 248.

With specific reference now to FIGS. 30 and 31, the second clamp member 238 will be further described. The second clamp member 238 can include a second clamp body 250 generally in the form of a ring having a central opening 252. The second clamp body 250 can generally comprise a second clamping surface 254 having a plurality of mounting features 256 formed thereon. In one example, the second clamp body 250 and the plurality of mounting features 256 can be formed as a unitary, monolithic part, such as by precision cast steel.

As will become appreciated by the following discussion, the second clamp member 238 is configured such that the second clamping surface 254 does not actually engage the sixth accessory 14f. In the example shown, the plurality of mounting features 256 are in the form of male conical protrusions 258. In the particular example shown, eight protrusions or male conical protrusions 258 are configured to each have a tapered body portion 260 that generally tapers from the second clamping surface 254 toward a tip 262. The tip 262 can generally comprise a spherical geometry. The male conical protrusions 258 each have a height 264 measured from the second clamping surface 254 to a terminal end 266 of the tip 262. The male conical protrusions 258 can further define an angle 270 measured from a longitudinal axis 272 to an outer surface 276 of the tapered body portion 260.

The male conical protrusions 258 can be configured to engage apertures of the sixth accessory 14f at a position intermediate the terminal end 266 of the tip 262 and the second clamping surface 254. Explained differently, the sixth accessory 14f can be clamped with the lever 232 in a first position and the clamp assembly 230 closed (FIG. 30), such that the sixth accessory 14f is offset a distance 280 from the second clamping surface 254. According to one example, the height 264 can be substantially about 4 mm and the angle 270 can be substantially about between 20° and 30° and more specifically 25°. A diameter of the male conical protrusions 258 measured at the second clamping surface 254 can be substantially about 3 mm. The surface finish of the male conical protrusions 258 can be sufficiently hard so as not to deform from interaction with the sixth accessory 14f. In one example, the male conical protrusions are at least 10 points (Rockwell hardness testing) harder than the sixth accessory 14f. Other heights and angles are contemplated.

With specific reference now to FIG. 30, the first clamp member 236 can generally include a first clamp member body 284 having an annular flange 286. The first clamp member body 284 can include a clamping surface 287 that has a plurality of mounting features 288 that are in the form of recesses that cooperatively receive the corresponding plurality of mounting features 256 of the second clamp member 238. The mounting features 288 can have any configuration, such as blind bores having diameters suitable to accept at least portions of the male conical protrusions 258 of the mounting features 256. The annular flange 286 can generally extend radially from an outer hub 290 of the first clamp member body 284. The annular flange 286 can have a lever opposing surface 291. The first clamp member body 284 can further include an inner hub 292 that defines a first clamp member opening 294. The first clamp member opening 294 can be configured to receive the spindle 226. An annular channel 296 can be formed between the outer hub 290 and the inner hub 292. The annular channel 296 can have a terminal surface 298.

The lever 232 can generally include a lever body 300 having the user engagement portion 242 formed generally on a first end and the pivot portion 246 formed on an opposite end. According to one example, the pivot portion 246 can generally include a pair of lobes 302 that each define an axle passage similar to the axle passage 104 described above with respect to FIG. 3. The lever body 300 can further include a pocket 308 having a flange opposing surface 310. A retainer plate 312 can be formed on the lever body 100. The retainer plate 312 can be configured to rest on the annular flange 286 when the lever 232 is released. The pivot axle 248 can be configured to pass through the respective axle passages of the lobes 302 and a corresponding axle passage 316 formed through an arm 318 extending from the housing 220.

The clamp arrangement 210 can additionally include a biasing member 320 and a washer 326. The biasing member 320 can be at least partially received by the annular channel 296 provided on the first clamp member body 284. The biasing member 320 can be generally supported on an upper end by a washer 326 that is correspondingly supported by a flange on the spindle 226. A distal end of the spindle 226 can be configured to attain a press fit relationship (through the central opening 252) with the second clamp body 250.

With particular reference now to FIG. 32, the sixth accessory 14f will be described. The sixth accessory 14f can generally be in the form of a cutting member having a working portion 346 and an attachment portion 348. The attachment portion 348 can include a plurality of mounting features 350 in the form of passages formed through the sixth accessory 14f. The attachment portion 348 can further include an open-ended aperture or throat 352 for selectively receiving a portion of the spindle 226 in an assembled position as will be described herein. According to one example of the present teachings, the plurality of mounting features 350 can be circular and have a diameter 358 of substantially about 2.8 mm. The throat 352 can define an angle 360 of about 60°. Other dimensions are contemplated. It will be appreciated however that the diameter 358 is selected to have a geometry such that it will engage the tapered body portion 260 of the male conical protrusions 258 at a location intermediate the terminal end 266 of the tip 262 and the second clamping surface 254. More particularly, the diameter 358 has a geometry that will ensure the attachment portion 348 does not bottom out or rest on top of the second clamping surface 254. In other words, the offset 280 (FIG. 30) must be greater than zero.

The mounting features 256 can be arranged to allow the sixth accessory 14f to be indexed at about 30° increments around the second clamping surface 254. Like the mounting features 76 described above, the mounting features 256 are absent at the two, four, eight and ten o′clock positions. It is further appreciated that the clamp assembly 230 can be used to clamp other accessories, such as described herein. Other configurations are contemplated.

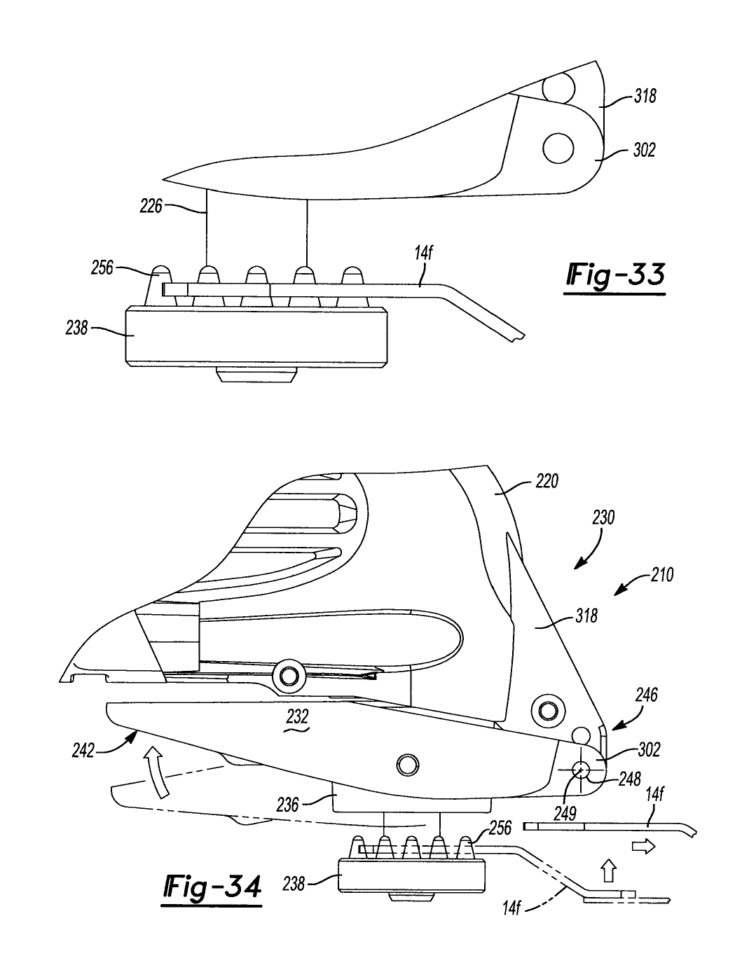

With specific reference now to FIGS. 30 and 34, an exemplary sequence of removing the sixth accessory 14f from the clamp assembly 230 will be described according to one example of the present teachings. With initial reference to FIG. 30, the clamp assembly 230 is shown in a closed position wherein the biasing member 320 is supported on a first end by the washer 326 and provides a downward biasing force onto the first clamp member 236 at the annular channel 296. It is important to recognize that in the particular example shown, the second clamp member 238 is fixed relative to the spindle 226. As shown, the male conical protrusions 258 selectively locate into the recesses of the mounting features 288 formed on the first clamp member 236. The sixth accessory 14f therefore is clamped between the clamping surface 287 and the outer surfaces 276 of the respective male conical protrusions 258. Again, the sixth accessory 14f is clamped at a location offset from the second clamping surface 254 of the second clamp member 238. As viewed in FIG. 30, the lever 232 is shown and generally described herein as the first position. Because the sixth accessory 14f is specifically engaged at the mounting features 350, the sixth accessory 14f can be securely fixed against the clamping surface 287 with minimal or no relative movement between the sixth accessory 14f and the clamp assembly 230.

Turning now specifically to reference FIG. 34, the lever 232 is shown rotated from the first position (phantom line) around the pivot axle axis 249 to a second position (solid line). In the second position, the clamp assembly 230 is generally in the open position where the first clamp member 236 is displaced or offset relative to the second clamp member 238. In order to move the lever 232 from the first position (phantom line, FIG. 34) to the second position (solid line, FIG. 34), a user can urge the user engagement portion 242 (such as by pulling the user engagement portion 242 with an index finger) in a direction generally upwardly as viewed in FIG. 34 and toward the housing 220. In order to rotate the lever 232 around the pivot axle 248, a user must overcome the biasing force of the biasing member 320 (FIG. 30). During rotation of the lever 232 around the pivot axle 248, the flange opposing surface 310 and the pocket 308 of the lever body 300 generally transmits an upward force (in a direction against the biasing force of the biasing member 320) onto the lever opposing surface 291. In this regard, the lever 232 can generally lift the first clamp member 236 at the annular flange 286 to move the clamping surface 287 away from the second clamp member 238.

With the clamp assembly 230 in the open position, the first and second clamp members 236 and 238, respectively, provide enough clearance, such that a user can remove the sixth accessory 14f away from the clamp assembly 230. In one example, it may be necessary to initially lift the sixth accessory 14f away from the male conical protrusions 258 before pulling the sixth accessory 14f away from the clamp assembly 230.

The pivot axle 248 can be located a distance 370 measured perpendicularly from a point 372 on a longitudinal centerline of the spindle 226. In one example, the distance 370 can be long enough to give the user a mechanical advantage to comfortably overcome the bias of the biasing member 320 when moving the lever 232 to the second position (clamp assembly 230 open). A distance 374 measured between the point 372 and a plane defined by the clamping surface 287 can be less than the distance 370.

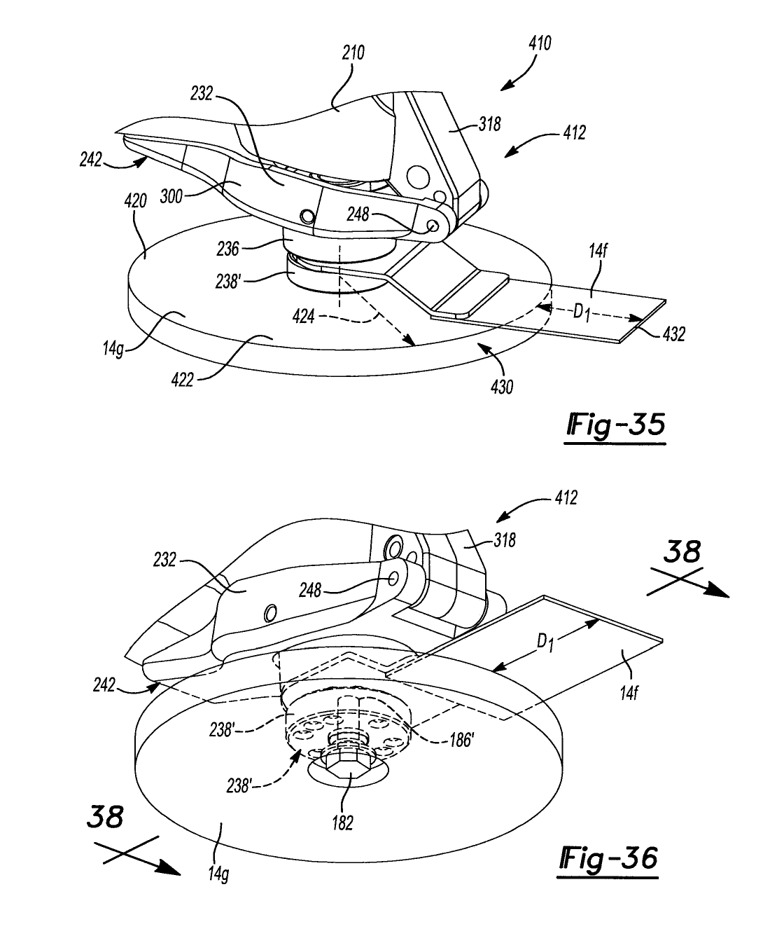

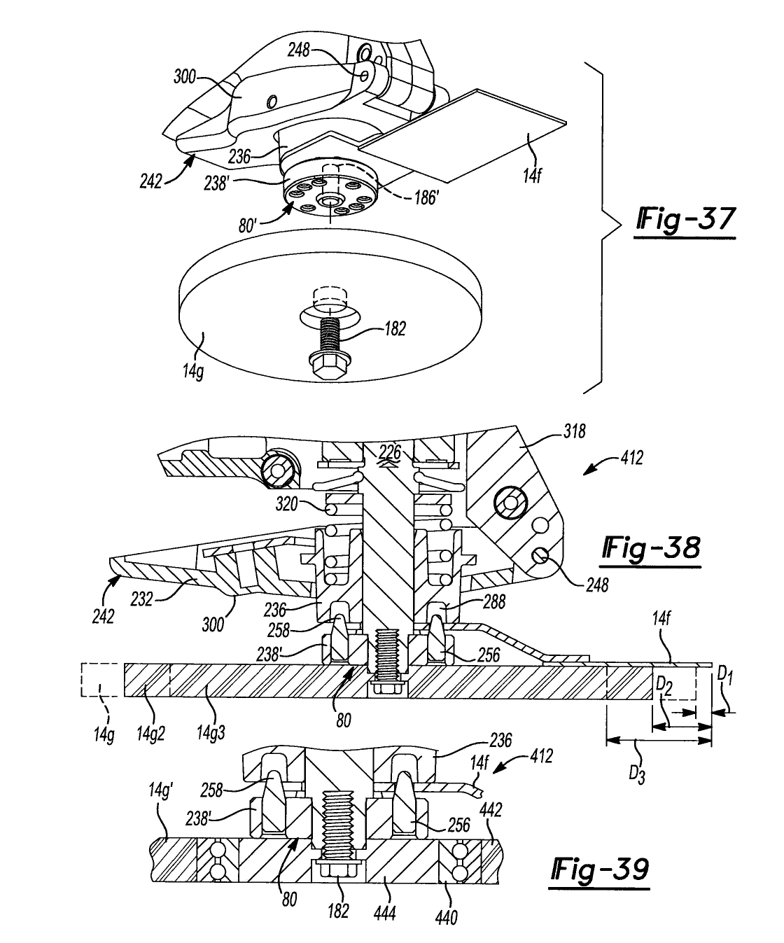

With reference now to FIGS. 35-46, a clamp arrangement constructed in accordance to another example of the present disclosure is shown and generally identified at reference numeral 410. The clamp arrangement 410 is shown operatively associated with a power tool 210 for selectively and alternatively retaining various accessories. In particular, the clamp arrangement 410 is configured for concurrently and simultaneously coupling two distinct accessories. Unless described otherwise herein, the clamp arrangement 410 incorporates similar components discussed above with respect to the clamp arrangement 10 and 210.

The clamp arrangement 410 includes a clamp assembly 412. The clamp assembly 412 operatively cooperates with the lever 232. The clamp assembly 412 can generally include the first clamp member 236 and a second clamp member 238′. The second clamp member 238′ is similarly constructed to the clamp member 238 described above with respect to FIG. 30. However the second clamp member 238′ incorporates an auxiliary attachment surface 80′ and a threaded bore 186′. The threaded bore 186′ is configured to threadably receive the fastener 182 as will be described herein.

With particular reference now to FIGS. 35-39, the clamp assembly 412 will be described concurrently retaining the sixth accessory 14f and a seventh accessory 14g. In the example provided, the seventh accessory 14g is a depth control member 420. The depth control member 420 has a body 422 generally in the form of a disk defining a passage 423. The body 422 has a diameter 424 and a work piece engagement surface 430. It will be appreciated that the depth control member 420, while shown in the drawings as having a constant diameter 424, may have different shapes and/or dimensions. For example, the engagement surface 430 can be inconsistent, planar, nautilus, etc. Furthermore, while the passage 423 is shown generally in the center of the body 422, it may be offset. The depth control member 420 can be coupled to the second clamp member 237′ of the clamp assembly 412 by threading the fastener 182 into the threaded bore 186′. The depth control member 420 can then locate and be fixed against the auxiliary attachment surface 80′.

The depth control member 420 can be configured to limit the cutting depth of a cutting edge 432 on the sixth accessory 14f. In this regard, the depth control member 420 can extend a predetermined distance relative to the cutting edge 432, such that a depth of cut D1 can be controlled. Explained further, while a user is performing a cutting action with the cutting edge 432 of the sixth accessory 14f, the work piece engagement surface 430 of the depth control member 420 can engage the work piece being cut and inhibit the cutting edge 432 from cutting into the work piece a distance greater than the depth D1. As can be appreciated, various seventh accessories 14g can be provided having distinct diameters for controlling a depth of cut for a given application (see FIG. 44, seventh accessories 14g, 14g2, 14g3 and 14g4). The depth control member 420 can be formed of any durable material such as plastic, metal, or other materials.

In one advantage of the clamp arrangement 410 according to the present teachings, a user can couple the sixth accessory 14f to the clamp assembly 412 alone or concurrently with the depth control member 420 coupled to the auxiliary attachment surface 80′. In this regard, it is contemplated that the user can easily swap out one of or both of the sixth accessory 14f and the seventh accessory 14g according to a given application. For example, a user may want to swap out between various seventh accessories 14g, 14g2 or 14g3 (FIG. 38) to provide various depths of cut D1, D2 or D3. In addition, the clamp arrangement 410 permits the user to swap out one of the sixth accessory 14f or the seventh accessory 14g at any time such as when one wears down from use. It can be appreciated that while the sixth accessory 14f is shown in FIG. 38 as engaging an upper surface of the body 422 of the depth control member 420, the sixth accessory 14f and the seventh accessory 14g may be laterally offset a predetermined distance relative to each other.

With reference to FIG. 39, a seventh accessory 14g′ is shown that incorporates a bearing 440 provided between an outer body 442 and an inner body 444. In this regard, the bearing 440 can permit the outer body 442 to rotate relative to the inner body 444 during use. Consequently, the outer body 442 is not fixed for oscillation with the sixth accessory 14f (or other accessory clamped with the clamp assembly 412).

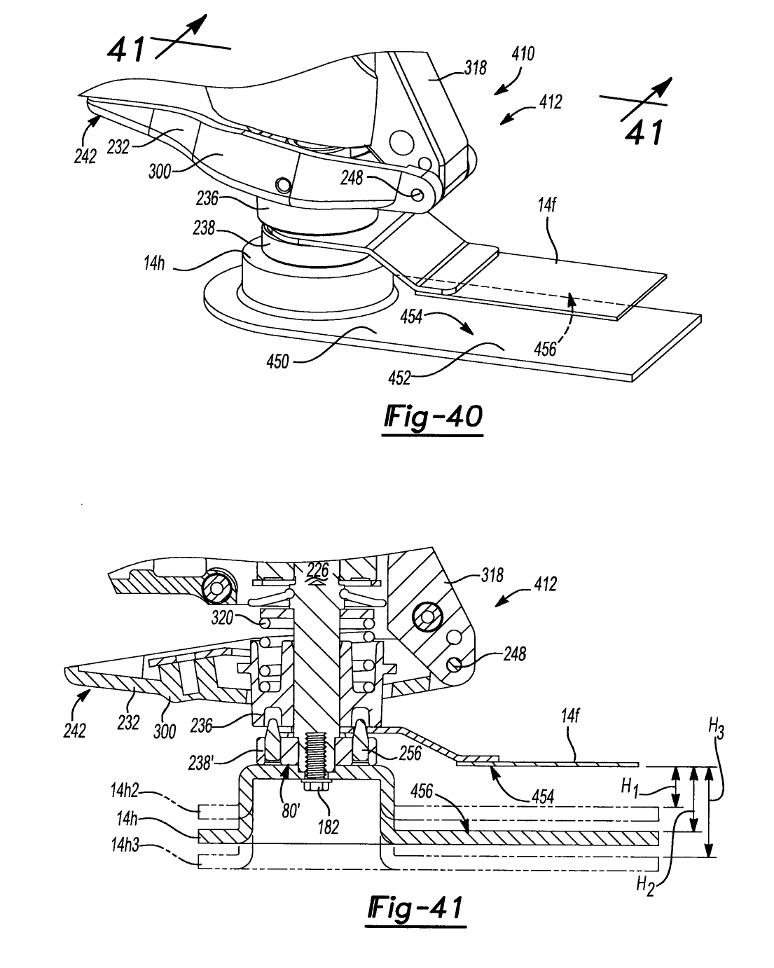

With particular reference now to FIGS. 40 and 41, the clamp assembly 412 will be described concurrently retaining the sixth accessory 14f and an eighth accessory 14h in the example provided, the eighth accessory 14h is an offset control member 450. The offset control member 450 has a body 452 that has a generally planar portion 453 and a hub portion 455. The planar portion 453 has an upper surface 454 and a lower surface 456. The hub portion 455 includes a passage 458. The offset control member 450 can be configured to provide a guide that facilitates making a cut parallel to or a consistent distance from another edge. In this regard, the planar portion 453 of the offset control member 450 can extend a predetermined offset distance relative to a surface 460 of the sixth accessory 14f. Explained further, the upper surface 454 of the offset control member 450 can be offset a height H₂ from the surface 460 of the sixth accessory 14f (FIG. 41). During use, the user can engage and/or slide a work piece along the upper or lower surface 454, 456 of the offset control member 450 such that the offset distance H₂ is known relative to the surface 460. In this way, as a user performs a cutting action with the sixth accessory 14f using the cutting edge 432, the offset control member 450 can be used to control the cutting offset distance relative to the work piece. As can be appreciated, various eighth accessories 14h can be provided having distinct offsets according to a given application (see also FIG. 44, eighth accessories 14h, 14h2, 14h3). The offset control member 450 can be formed of any durable material such as plastic, metal, or other materials.

As with the configuration discussed above with respect to FIGS. 35-39, a user can couple the sixth accessory 14f to the clamp assembly 412 alone or concurrently with the offset control member 450 coupled to the auxiliary attachment surface 80′. As such, it is contemplated that the user can easily swap out one of or both of the sixth accessory 14f and the eighth accessory 14h according to a given application. For example, a user may want to swap out between various eighth accessories 14h, 14h2 and 14h3 (FIGS. 41 and 44) to provide various offsets h2, h1, and h3, respectively. Additionally, the clamp arrangement 410 permits the user to swap out one of the sixth accessory 14f or the eighth accessory 14h as one wears down from use.

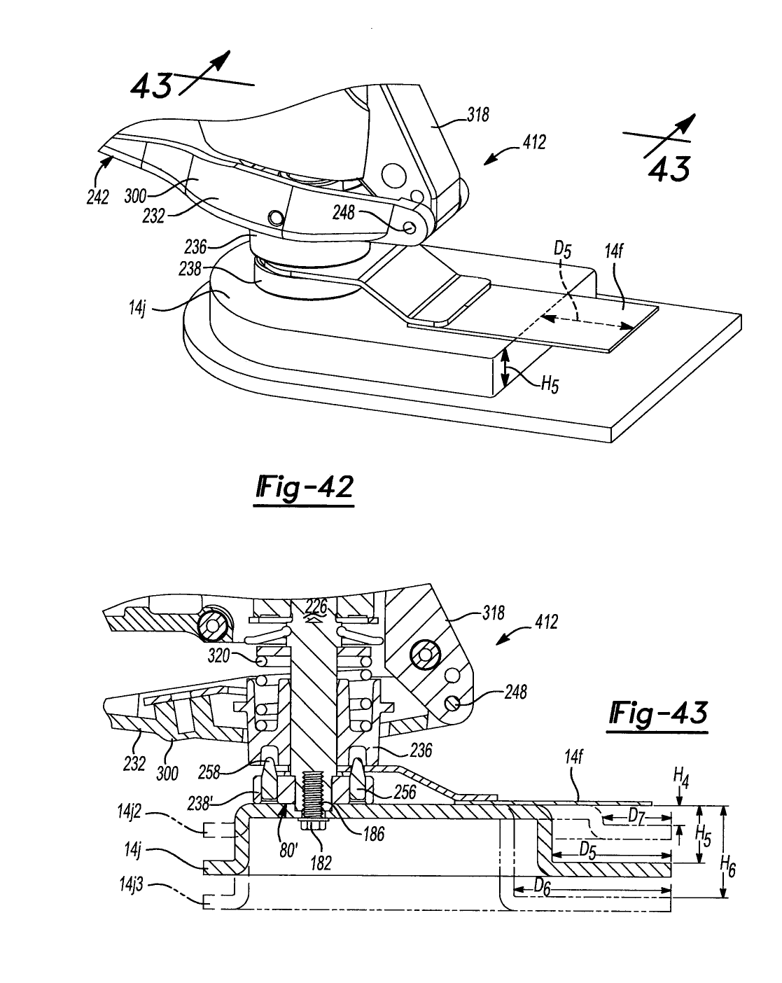

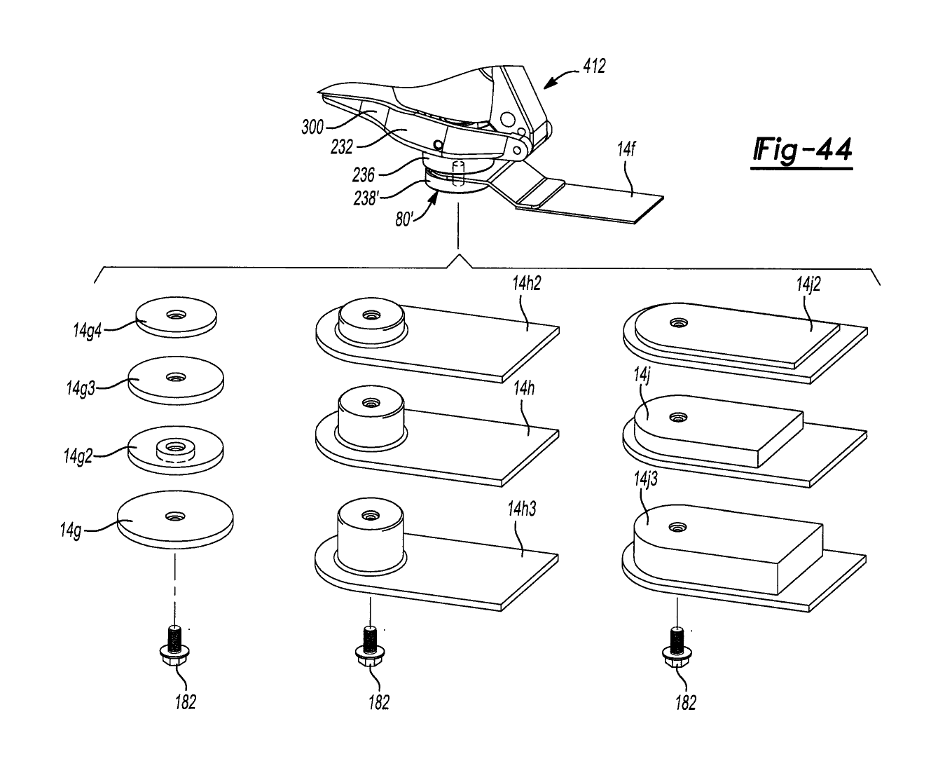

With reference now to FIGS. 42 and 43, the clamp assembly 412 will be described concurrently retaining the sixth accessory 14f and a ninth accessory 14j. In the example provided, the ninth accessory 14j is a combination depth and offset control member 470. More specifically, the combination depth and offset control member 470 includes a depth control portion 472 and an offset control portion 474. A passage 476 is formed through the depth control portion 472 of the combination depth and offset control member 470. The combination depth and offset control member 470 can be formed of any durable material such as plastic, metal, or other materials.

As can be appreciated, the combination depth and offset control member 470 can provide the advantages of both of the depth control member 422 and offset control member 450 described above. In this regard, the depth control portion 472 has a work piece engagement surface 478 that can extend a predetermined distance D₅ relative to the cutting edge 432 of the sixth accessory 14f. Similarly, the offset control portion 474 can include an upper surface 480 that is offset a distance H₅ from the surface 460 of the sixth accessory 14f.

As illustrated in FIG. 43, various ninth accessories 14j, 14j2, and 14j3 may be provided that offer various combinations of depths (D₅, D₆, and D₇) and offsets (H₄, H₅, and H₆). Again, as with the other scenarios discussed above, a user can couple the ninth accessory to the clamp assembly 412 alone or concurrently with the ninth accessory 14j coupled to the auxiliary attachment surface 80′. In this regard, it is contemplated that the user can easily swap out one of or both of the sixth accessory 14f and the ninth accessory 14j according to a given application. For example, a user may want to swap out between various ninth accessories 14j, 14j2, and 14j3 to provide various combinations of depths of cut (D₅, D₆, and D₇) and offsets (H₄, H₅, and H₆).

With reference now to FIG. 44, a kit 490 of accessories may be provided such that the user may easily exchange between various accessories according to a given application. While the seventh accessories 14g, 14g2, 14g3, and 14g4, eighth accessories 14h, 14h2, and 14h3 and the ninth accessories 14j, 14j2, and 14j3 are illustrated as having various shapes and sizes, those skilled in the art will readily appreciate that other accessories having various combinations of geometries may be provided within the scope of the present teachings. Again, it will also be appreciated that while the clamp assembly 412 is shown operatively clamping the sixth accessory 14f, the clamp assembly 412 may alternatively be used to clamp other accessories such as disclosed herein.

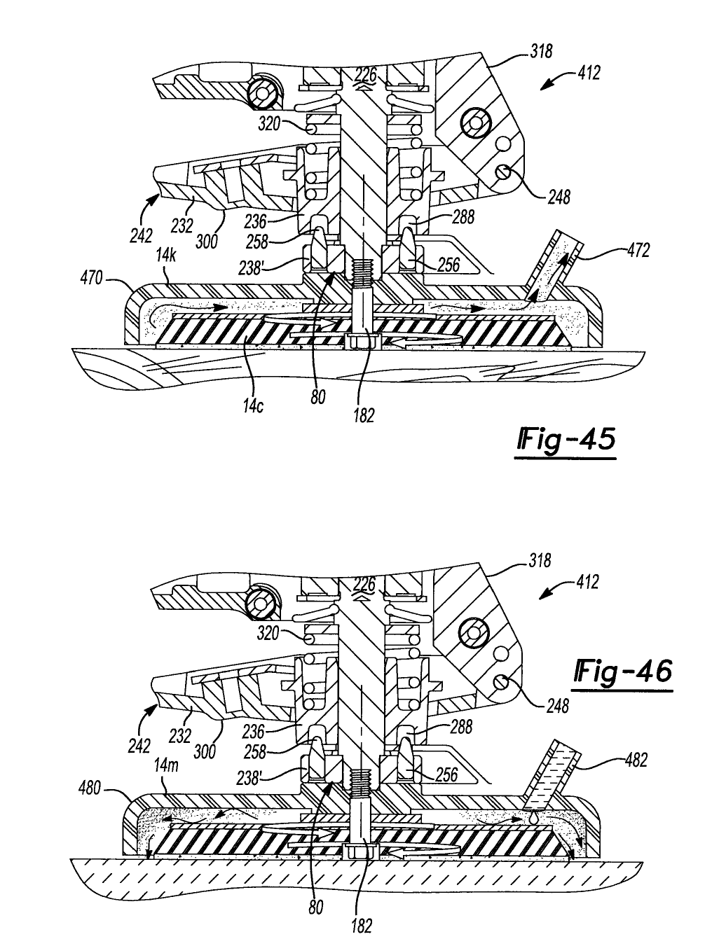

Turning now to FIG. 45, the clamp assembly 412 will be described concurrently retaining a tenth accessory 14k and third accessory 14c. The third accessory 14c can generally comprise a sanding platen as described above and known in the art. The tenth accessory 14k can have a clamping portion 502 that is configured to be clamped by the clamp assembly 412. The tenth accessory 14k generally includes an outer containment dome 506 having a chute 508. The containment dome 506 can be configured to encourage dust and/or debris that is being sanded to be directed up through the chute 508. The chute 508 can be connected to a vacuum according to one application. Additionally, the user can easily swap out one of the third accessory 14c or tenth accessory 14k without disturbing the other accessory.

With reference to FIG. 46, the clamp assembly 412 is shown concurrently retaining an eleventh accessory 14m and twelfth accessory 14n. The eleventh accessory 14m generally includes a clamping portion 512 that is configured to be clamped by the clamp assembly 412. The eleventh accessory 14m further includes a containment dome 516 having a chute 518 that is configured to administer a polishing fluid 520. The twelfth accessory 14n can be configured similar to the third accessory 14c but may have a work piece engaging surface 524 that is configured to polish the work piece while the fluid 520 is delivered through the chute 518. In one example, a reservoir may be connected to the chute 518 and be configured to administer the fluid 520. Again, the configuration provided in FIG. 46 can allow a user to easily swap out either of the eleventh accessory 14m or twelfth accessory 14n without disturbing the other accessory.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A clamp arrangement for securing first and second accessories to an oscillating power tool, the clamp arrangement comprising:
a tool body including a motor having an output member that drives the first accessory;
a clamp assembly including a first clamp member that moves relative to the first accessory between a closed position wherein the clamp assembly retains the first accessory and an open position wherein the first clamp member of the clamp assembly is offset from the first accessory permitting removal of the first accessory from the clamp assembly while the first clamp member remains coupled to the clamp assembly, the clamp assembly further comprising a second clamp member having a first portion that opposes the first clamp member and cooperates with the first clamp member to clamp the first accessory between the first and second clamp members; and
an auxiliary attachment surface configured on the second clamp member, distinct from the second clamping surface and configured to selectively connect with the second accessory while the first accessory is concurrently retained by the clamp assembly.

2. The clamp arrangement of claim 1 wherein the first clamp member comprises a first clamp body having one of a first plurality of protrusions extending from a first clamping surface and a first plurality of recesses formed into the first clamping surface.

3. The clamp arrangement of claim 2 wherein the second clamp member comprises a second clamp body having a second clamping surface that opposes the first clamping surface and includes the other of the first plurality of protrusions and first plurality of recesses, wherein the first plurality of protrusions are configured to cooperatively locate into the corresponding first plurality of recesses in the closed position.

4. The clamp arrangement of claim 1, further comprising an actuator having a user engagement portion and being movably coupled relative to the tool body between a first position, wherein the clamp assembly is in the closed position and a second position wherein movement of the user engagement portion of the actuator causes the clamp assembly to be moved to the open position.

5. The clamp arrangement of claim 1, further comprising the first accessory wherein the first accessory has an open ended aperture and a plurality of mounting formations therethrough, the first plurality of protrusions each having a conical outer surface that locates partially through and engages the plurality of mounting formations of the accessory in the closed position, wherein the first accessory is positioned offset from the second clamping surface of the second clamp body.

6. The clamp arrangement of claim 1, further comprising a lever having a user engagement portion and a pivot portion including a pivot axle, the lever being pivotally coupled relative to the tool body about the pivot axle between a first position, wherein the clamp assembly is in the closed position and a second position wherein movement of the user engagement portion of the lever causes the clamp assembly to be moved to the open position.

7. The clamp arrangement of claim 1 wherein the second clamp member defines a threaded bore configured to receive a fastener that couples the second accessory to the auxiliary attachment surface.

8. The clamp arrangement of claim 1, further comprising the second accessory, wherein the second accessory comprises a depth control member having a work piece engagement surface that is configured to be spaced a predetermined distance from a cutting edge of the first accessory, the work piece engagement surface configured to engage the work piece and inhibit the cutting edge from cutting into a work piece a distance greater than the predetermined distance.

9. The clamp arrangement of claim 1, further comprising the second accessory, wherein the second accessory comprises an offset control member having a work piece engagement surface that is configured to be spaced a predetermined lateral distance from a surface of the first accessory, the work piece engagement surface configured to engage the work piece and maintain the first accessory at the predetermined lateral distance from the work piece engagement surface.

10. The clamp arrangement of claim 1, further comprising the second accessory, wherein the second accessory comprises a combination depth and offset control member having a first work piece engagement surface that is configured to be spaced a predetermined distance from a cutting edge of the first accessory and a second work piece engagement surface that is configured to by spaced a predetermined lateral distance from a body of the first accessory, the first work piece engagement surface configured to engage the work piece and inhibit the cutting edge from cutting into a work piece a distance greater than the predetermined distance, the second work piece engagement surface configured to engage the work piece and maintain the first accessory at the predetermined lateral distance from the second work piece engagement surface.

11. The clamp arrangement of claim 1, further comprising the first accessory and the second accessory, wherein the first accessory includes a dust extraction device and the second accessory includes a sanding platen.

12. The clamp arrangement of claim 1, further comprising the first accessory and the second accessory, wherein the first accessory includes a lubricating device and the second accessory includes a polishing platen.

13. A clamp arrangement for securing first and second accessories to an oscillating power tool, the clamp arrangement comprising:
a tool body including a motor having an output member that drives the first accessory; and
a clamp assembly including a first clamp member and a second clamp member, wherein one of the first and second clamp members moves relative to the other clamp member between an open position and a clamped position to selectively retain the first accessory between the first and second clamp members, and wherein one of the first and second clamp members includes an auxiliary attachment surface configured to selectively connect with the second accessory while the first accessory is concurrently retained by the clamp assembly.

14. The clamp arrangement of claim 13 wherein the first and second clamp members include first and second surfaces, respectively and wherein the auxiliary attachment surface includes a third surface, wherein the first and second surfaces oppose each other while the third surface faces away from both of the first and second surfaces.

15. The clamp arrangement of claim 14 wherein the auxiliary attachment surface is formed on the second clamp member and wherein the second clamp member defines a threaded bore configured to receive a fastener that couples the second accessory to the auxiliary attachment surface.

16. The clamp arrangement of claim 13, further comprising the second accessory, wherein the second accessory comprises a depth control member having a work piece engagement surface that is configured to be spaced a predetermined distance from a cutting edge of the first accessory, the work piece engagement surface configured to engage the work piece and inhibit the cutting edge from cutting into a work piece a distance greater than the predetermined distance.

17. The clamp arrangement of claim 13, further comprising the second accessory, wherein the second accessory comprises an offset control member having a work piece engagement surface that is configured to be spaced a predetermined lateral distance from a surface of the first accessory, the work piece engagement surface configured to engage the work piece and maintain the first accessory at the predetermined lateral distance from the work piece engagement surface.

18. The clamp arrangement of claim 13, further comprising the second accessory, wherein the second accessory comprises a combination depth and offset control member having a first work piece engagement surface that is configured to be spaced a predetermined distance from a cutting edge of the first accessory and a second work piece engagement surface that is configured to by spaced a predetermined lateral distance from a body of the first accessory, the first work piece engagement surface configured to engage the work piece and inhibit the cutting edge from cutting into a work piece a distance greater than the predetermined distance, the second work piece engagement surface configured to engage the work piece and maintain the first accessory at the predetermined lateral distance from the second work piece engagement surface.

19. The clamp arrangement of claim 13, further comprising the first accessory and the second accessory, wherein the first accessory includes one of a dust extraction device and a lubricating device and wherein the second accessory includes one of a sanding platen and a polishing platen.

20. A clamp arrangement for securing first and second accessories to an oscillating power tool, the clamp arrangement comprising:
a tool body including a motor having an output member that drives the first accessory; and
a clamp assembly including a first clamp member and a second clamp member, wherein one of the first and second clamp members moves relative to the other clamp member between an open position and a clamped position to selectively retain the first accessory between opposing surfaces of the first and second clamp members, and wherein one of the first and second clamp members includes an auxiliary attachment surface, distinct from the opposing surfaces and configured to selectively connect with the second accessory;
wherein the clamp arrangement is operable in a first mode wherein the clamp arrangement only retains the first accessory, a second mode wherein the clamp arrangement only retains the second accessory, and a third mode wherein the clamp assembly concurrently retains both of the first accessory and the second accessory.
